(19) United States
(12) Patent Application Publication
(10) Pub. No.: US 2015/0135208 A1
(43) Pub. Date: May 14, 2015

(54) CONTENT DISTRIBUTION CONTROL PROGRAM, CONTENT DISTRIBUTION CONTROL DEVICE, CONTENT DISTRIBUTION DEVICE AND CONTENT DISTRIBUTION SYSTEM

(71) Applicant: Hitachi Maxell, Ltd., Osaka (JP)

(72) Inventor: Tsuguo Itagaki, Ibaraki (JP)

(73) Assignee: Hitachi Maxell, Ltd., Osaka (JP)

(21) Appl. No.: 14/401,188

(22) PCT Filed: Mar. 11, 2013
(86) PCT No.: PCT/JP2013/056562

§ 371 Date: Nov. 14, 2014

(30) Foreign Application Priority Data
May 17, 2012 (JP) 2012-113599

(51) Int. Cl. H04N 21/8355; H04N 21/482; H04N 21/658; H04N 21/4363

(52) U.S. Cl. CPC H04N 21/8355; H04N 21/4363; H04N 21/4821; H04N 21/6582
USPC 725/25

(57) ABSTRACT

An object of the present invention is to provide a content viewing system capable of carrying out cooperation among devices while ensuring security and copyright management. The system is characterized by allowing an information processing device to execute the steps of: notifying a content management device of device identification information for identifying a device selected on a device selection screen and content identification information for identifying content selected on a content selection screen; and making the selected device have an access to the content management device by notifying the selected device of a viewing instruction of content selected on the content selection screen and information of an address to have an access to the content management device.

### TECHNICAL FIELD

The present invention relates to a content distribution control program, a content distribution control device, a content distribution device and a content distribution system.

### BACKGROUND

In recent years, a portable information terminal such as a mobile phone, a smartphone or the like has been used as a remote controller of an electric home appliance such as a television receiver or the like. This function is realized by, for example, transmitting an infrared signal, which is the same as that of a remote controller attached to an electric home appliance, by using an infrared signal transmitting function installed in the portable information terminal.

On the other hand, as a solution for the problems with a communicable range and directivity raised in the case of using the infrared communication function, a remote commander provided with a network communication function has been proposed (see, for example, Patent Document 1). Patent Document 1 describes that, since bidirectional communications are available between a remote controller and a control target device, more reliable communication can be carried out by delivery confirmation, a complex command system utilizing a GUI (Graphical User Interface) operation can be adopted, and a large capacity data transmission such as moving image streaming and the like can be carried out by using a comparatively wide band.

### PRIOR ART DOCUMENTS

### Patent Documents

Patent Document 1: Japanese Patent Application Laid-Open Publication No. 2009-055614

### SUMMARY

### Problems to be Solved by the Invention

The above-mentioned Patent Document 1 does not disclose the processes and the like required depending on various use environments and use conditions, and the user friendliness is insufficient. For example, Patent Document 1 discloses that a received video content is displayed on the remote commander and the content being viewed on the remote commander is displayed on a television receiver.

In the device control by wireless communication, it is necessary to limit the objects permitted to perform the wireless operation for the purpose of security. Moreover, in order to view the contents comfortably, it is desirable to display the contents on a large-size screen such as a television receiver, but in the case where the control like this is to be carried out by the operation through a wireless terminal, the control for three devices including a server for supplying the contents, a television receiver and the wireless terminal is required, and cooperation among the devices is required while ensuring the above-mentioned security and copyright management.

The present invention has been made in view of the problem mentioned above, and an object of the present invention is to provide a content viewing system capable of achieving the cooperation among devices, while ensuring security and copyright management.

### Means for Solving the Problems

For the solution of the problem above, an aspect of the present invention is a wireless operation controlling program for controlling viewing of contents by a certain device by an operation through a wireless communication from another device, and the program allows an information processing device to execute the steps of: displaying a device selection screen for selecting a device used in the viewing of content; displaying a content selection screen for selecting content to be viewed; notifying a content management device, which provides information to be acquired for the viewing of the content, of device identification information for identifying a device selected on the device selection screen and content identification information for identifying content selected on the content selection screen; and making the selected device have an access to the content management device by notifying the device selected on the device selection screen of a viewing instruction of the content selected on the content selection screen and information of an address to have an access to the content management device.

Also, another aspect of the present invention is a wireless terminal for controlling viewing of contents by a certain device by an operation through a wireless communication from another device, and the wireless terminal includes: a device selection screen display unit for displaying a device selection screen for selecting a device to be used for the viewing of content on a display unit; a content selection screen display unit for displaying a content selection screen for selecting the content to be viewed on the display unit; an identification information notification unit for notifying a content management device, which provides information to be acquired for the viewing of the content, of device identification information for identifying a device selected on the device selection screen and content identification information for identifying content selected on the content selection screen; and a viewing instruction notification unit for notifying the device selected on the device selection screen of a viewing instruction of the content selected on the content selection screen and information of an address to have an access to the content management device.

Still another aspect of the present invention is a content management device, which provides information relating to contents in a content viewing system in which viewing of contents by a certain device is controlled by an operation through a wireless communication from another device, and the device includes: a device identification information acquiring unit for acquiring device identification information for identifying a device selected as a device to be used for the viewing of the contents; an information acquiring request receiver unit for receiving an acquiring request of information to be acquired by the device at the viewing of the contents from the selected device; and a device determination unit which, if a transmission source of the received acquiring request matches with the acquired device identification information, transmits the information to be acquired by the device at the viewing of the contents to the transmission source of the acquiring request.

Still another aspect of the present invention is a content viewing system having: a wireless terminal for controlling viewing of content by a certain device by an operation through a wireless communication from another device; and a content management device for providing information relating to the content to a device used for the viewing of the content, the wireless terminal includes: a device selection screen display unit for displaying a device selection screen for selecting a device to be used for the viewing of the content on a display unit; a content selection screen display unit for displaying a content selection screen for selecting content to be viewed on the display unit; an identification information notification unit for notifying the content management device of device identification information for identifying a device selected on the device selection screen and content identification information for identifying content selected on the content selection screen; and a viewing instruction notification unit for notifying the device selected on the device selection screen of a viewing instruction of the content selected on the content selection screen and information of an address to have an access to the content management device, and the content management device includes: a device identification information acquiring unit for acquiring device identification information for identifying a device selected as a device to be used for the viewing of the content; an information acquiring request receiver unit for receiving an acquiring request of information to be acquired by the device at the viewing of the content from the selected device; and a device determination unit which, if a transmission source of the received acquiring request matches with the acquired device identification information, transmits the information to be acquired by the device at the viewing of the content to the transmission source of the acquiring request.

### Effects of the Invention

According to the present invention, it is possible to provide a content viewing system capable of achieving the cooperation among devices, while ensuring security and copyright management.

### BRIEF DESCRIPTION OF THE DRAWINGS

FIG. 1 is a block diagram showing a system configuration example according to an embodiment of the present invention;

FIG. 2 is a block diagram showing a configuration example of a television receiver according to the embodiment of the present invention;

FIG. 3 is a block diagram showing a configuration example of a wireless terminal according to the embodiment of the present invention;

FIG. 4 is a block diagram showing a configuration example of a content distribution server according to the embodiment of the present invention;

FIG. 5 is a diagram showing an example of an internal configuration of a storage and a memory of the television receiver according to the embodiment of the present invention;

FIG. 6 is a diagram showing an example of an internal configuration of a storage and a memory of the wireless terminal according to the embodiment of the present invention;

FIG. 7 is a diagram showing an example of an internal configuration of a storage and a memory of the content distribution server according to the embodiment of the present invention;

FIG. 8 is a diagram showing a data table representing an example of information to be managed by the content distribution server according to the embodiment of the present invention;

FIG. 9 is a diagram showing an example of an operation sequence of a system according to the embodiment of the present invention;

FIG. 10 is a diagram showing a display example of a menu screen of the wireless terminal according to the embodiment of the present invention;

FIG. 11 is a diagram showing a display example of a content list display screen of the wireless terminal according to the embodiment of the present invention;

FIG. 12 is a diagram showing a display example of a content detail display screen of the wireless terminal according to the embodiment of the present invention;

FIG. 13 is a diagram showing a display example of a connection device list display screen of the wireless terminal according to the embodiment of the present invention;

FIG. 14 is a diagram showing an example of an operation sequence of the system according to the embodiment of the present invention;

FIG. 15 is a diagram showing a display example of a content operation screen of the wireless terminal according to the embodiment of the present invention;

FIG. 16 is a diagram showing a display example in the case where content is reproduced on the display screen of the television receiver according to the embodiment of the present invention;

FIG. 17 is a diagram showing a display example in the case where content is reproduced on the display screen of the wireless terminal according to the embodiment of the present invention;

FIG. 18 is a diagram showing an example of an internal configuration of a storage and a memory of a content distribution server according to another embodiment of the present invention;

FIG. 19 is a diagram showing an example of an operation sequence of a system according to the embodiment of the present invention;

FIG. 20 is a diagram showing an example of an operation sequence of a system according to still another embodiment of the present invention;

FIG. 21 is a diagram showing an example of an operation sequence of the system according to the embodiment of the present invention;

FIG. 22 is a diagram showing a display example of a content list display screen of a wireless terminal according to the embodiment of the present invention; and

FIG. 23 is a diagram showing a display example of a content detail display screen of the wireless terminal according to the embodiment of the present invention.

### DETAILED DESCRIPTION

### First Embodiment

Hereinafter, embodiments of the present invention will be described with reference to the drawings. In the description of the embodiments, a service for distributing contents such as video images, audio data, character information, and the like through the Internet (hereinafter, referred to as IPTV service) is taken as an example, but the embodiments are not limited to the IPTV service.

The IPTV service is broadly classified into three services, that is, streaming, download and progressive download based on the formats thereof. In the streaming, content data from a server are successively distributed to a client, and the client reproduces video images, audio data, and others from the arrived data, thereby presenting them to the user. For this reason, this service is characterized in that the user can view the contents virtually in real time in the case where a network having a sufficiently wide band is available.

In the download, the client preliminarily acquires and stores all the content data from the server, and the viewing and reproducing of the contents are carried out after the completion of the accumulation. For this reason, this service is characterized in that, in the case where it is not necessary to view the contents in real time, the user can view the contents as many times as desired at a desired timing by preliminarily completing the distribution and the accumulation of all the content data, and the distribution of contents can be received even when a network having a sufficiently wide band is not available.

Moreover, the progressive download is located between the above-mentioned two services, and the contents accumulated in the terminal are successively viewed prior to the completion of the distribution of all the contents. Therefore, it is not always necessary to wait for the completion of the accumulation and the accumulation time can be shortened even when the band is not sufficiently wide, and further it is possible to provide an advantage that the user can view the contents many times at a desired timing after the completion of the accumulation.

In the content distribution service including the IPTV service, in most cases, the usage fee is imposed by the service provider in exchange for the receipt of the distribution service by the user. At this time, the user is preliminarily registered as an authorized user, and various types of information such as a password (or biological information including a finger print), a name, an address and others are managed based on an identifier (ID).

In the case of a distribution of contents to be charged, charging information in accumulating or viewing the contents can be recorded, and it is confirmed that the usage fee can be paid by a payment method specified separately. At the stage of using the distribution service, the user needs to receive the user authentication for making the service available by performing the collation between the registered information and the management information by means of the identifier (ID) and the password. For the authorized user who has been thus authenticated, a content viewing portal screen for use in selecting or retrieving contents to be distributed and selecting services such as the distribution of other information is provided in most cases.

Moreover, a device authentication for confirming whether or not a device to be used by the user is a device recommended by the service provider or whether or not a program for receiving the distribution service operated in the device is a program recommended by the service provider is carried out by communication prior to the distribution service in most cases. Thus, actions violating the copyright laws such as copying, transporting, revising and the like without permission and unauthorized use of contents are prevented.

At this time, the contents are preliminarily encoded by a common-key encryption method, and a key for decoding the code is separately retained in association with the contents to be received in some cases so that only the authenticated authorized user can decode the contents, the contents are decoded by only the authenticated authorized connection device, and only the authenticated authorized user can decode the contents by only the authenticated authorized connection device. Moreover, by preparing a public key and a private key on the connection device side or the service provider side by using a public-key encryption method and transmitting the private key to the connection device at the time of the user registration or the like, the keys may be used for the encoding and the decoding in the service provider and the connection device, respectively. In general, these keys for use in decoding are recorded together with the time limit and the number of content reproductions and reproducing conditions such as the user and the device capable of reproducing the contents. Hereinafter, the key for use in encoding is referred to as “encryption key”, and the key for use in decoding is referred to as “decryption key”.

As described above, the service provider of IPTV service safely provides a content distribution service or the like to the user by the user authentication, the device authentication and the association of a decryption key, and carries out the reliable charging instead of a provider of contents and service. Thereafter, the user can receive the distribution of desired contents and correctly enjoy services such as the reproduction of the contents. Moreover, based on these services, the user can retain the contents associated so as to correspond to the right for reproduction based on copyright in some cases.

The user reproduces the contents thus obtained or reproduces the contents by a predetermined device by using a decryption key, and these are normally carried out on the assumption that the same user reproduces the contents by the same device. Meanwhile, in the case where the same user has a plurality of devices and wishes to reproduce the same contents by another device, there is an inconvenience that the fee is imposed again on the same contents. For this reason, there is the service in which the reproduction of the contents by a plurality of devices is allowed within the range of the number of devices permitted by the service provider as long as the user has the right for reproduction. In this case, the service provider is required to correctly manage the user and the number of devices to be permitted in association with each other.

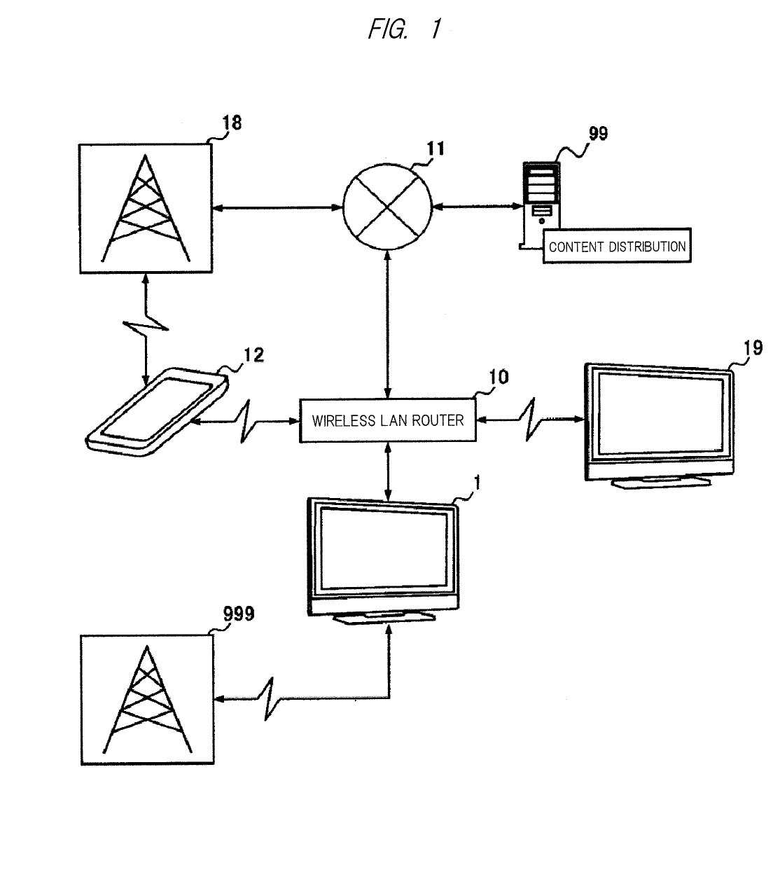

FIG. 1 is a block diagram showing one embodiment of a network terminal system according to the present embodiment. The network terminal system according to the present embodiment is made up of, for example, a television receiver 1, a television receiver 19, a wireless terminal 12, a wireless LAN (Local Area Network) router 10, an external network 11 and a content distribution server 99. FIG. 1 shows the example in which the user of the wireless terminal 12 which is a mobile communication terminal serving as an information communication terminal such as a mobile phone is viewing a television program by the television receiver 1 at home or at a shop or the like with the wireless terminal 12 in hand.

The wireless LAN router 10 has a wireless LAN function such as Wi-Fi and can be connected to the external network 11 by way of a communication line. Moreover, the wireless LAN router 10 is connected to the television receiver 1, the television receiver 19, the wireless terminal 12 and the external network 11, and the television receiver 1, the television receiver 19 or the wireless terminal 12 can obtain information from the Internet network.

Moreover, it is assumed that the wireless LAN router 10 is connected to the television receiver 1 or the television receiving 19 through a wired LAN or a wireless LAN, and is connected to the wireless terminal 12 through a wireless LAN. Here, Wi-Fi corresponds to a wireless LAN standard defined based on the IEEE (Institute of Electrical and Electronics Engineers) standards “IEEE802.11a/IEEE802.11b”.

The content distribution server 99 is a content management device for accumulating contents such as video and audio data and distributing the contents in response to a request from the wireless terminal 12 or the television receiver 1 connected to the network. The content distribution server 99 is connected to the external network 11, and the wireless terminal 12 or the television receiver 1 can transmit and receive information to and from the content distribution server 99 connected to the external network 11 by way of the wireless LAN router 10 and can receive contents and information relating to contents such as a key for decoding the encoded contents. Moreover, the wireless terminal 12 is connected to a communication network through a base station 18 by utilizing a mobile communication network, and can transmit and receive information and receive contents also through the external network connected to the communication network.

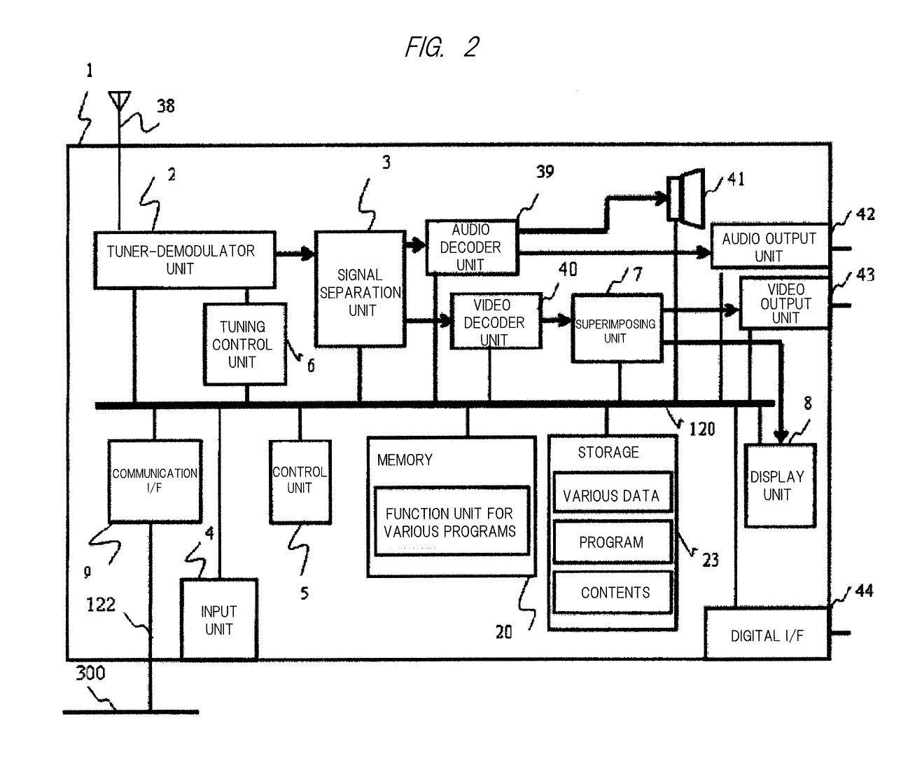

FIG. 2 is a diagram showing an example of a configuration of the television receiver 1. The television receiver 1 is connected to an antenna 38 and includes a tuner-demodulator unit 2, a signal separation unit 3, a control unit 5, a tuning control unit 6, an input unit 4, a storage 23, a memory 20, a superimposing unit 7, a display unit 8, a communication interface 9, an audio decoder unit 39, a video decoder unit 40, a speaker 41, an audio output unit 42, a video output unit 43 and others. These processing units are respectively connected to one another through a bus 120.

Moreover, the television receiver 1 can store an application program in the storage 23, and the control unit 5 can realize various functions by loading the above-mentioned program from the storage 23 into the memory 20 and carrying out operations in accordance with the program. For the sake of simplification, the following description will be made on the assumption that various functions realized by carrying out operations in accordance with each of application programs by the control unit 5 are realized mainly by a function unit for various programs.

Note that the application programs may be preliminarily stored in the storage 23 before the shipment of the television receiver 1, or may be stored in a medium including an optical medium such as a CD (Compact Disk) or a DVD (Digital Versatile Disk) and a semiconductor memory and installed in the television receiver 1 through a medium connection unit (not shown). Moreover, the programs may be downloaded and installed from the external network 11 through the communication interface 9 and the wireless router 10. Furthermore, the various functions of the application programs may be realized by hardware as processing units having the same functions. In the case where the functions are realized by hardware, the respective functions are realized mainly by the respective processing units.

The input unit 4 serves as an input unit that receives an operation given to the television receiver 1 from the user and inputs control information relating to an input operation, and it is realized by, for example, a remote controller, a keyboard or a pointing device such as a mouse.

The control unit 5 receives an operation request from the user through the input unit 4, and controls respective blocks such as the signal separation unit 3, the tuning control unit 6, the storage 23, the superimposing unit 7, the communication interface 9, and the function unit for various programs. The storage 23 is controlled by the instruction from the control unit 5 and can store the application programs. Moreover, the storage 23 stores various types of information formed by the application programs. Furthermore, contents such as video audio streams derived from the signals received through the tuner-demodulator unit 2 and the communication interface 9 may be stored therein.

The memory 20 is controlled by the instruction from the control unit 5. The function units of the application programs stored in the storage 23 are loaded into the memory 20. The tuner-demodulator unit 2 is synchronized with a channel of a desired service by the tuning control unit 6, thereby receiving a broadcasting signal from a broadcasting station 999, and acquiring a transport stream by demodulating the received broadcasting signal.

Note that, in the example of FIG. 2, for the sake of simplification, the configuration having one tuner-demodulator unit 2 is shown. However, in the case where a function of carrying out viewing and recording in parallel with each other or a function of simultaneously viewing contents of a plurality of channels having different transmission frequencies is to be installed, a plurality of tuner-demodulator units 2 may be installed therein. Therefore, in the following description, it is not always necessary that the tuner-demodulator units 2 are all the same. Different tuner-demodulator units may be used depending on the respective processes.

The tuning control unit 6 receives an instruction for tuning the service by way of the input unit 4, and controls the tuner-demodulator unit 2 so as to switch the channel to be tuned in accordance with the instruction. Moreover, the tuning control unit 6 can receive instructions from the function unit for various programs, and controls the tuner-demodulator unit 2 so as to make the switch to a service (channel number) that is broadcasting an event (program) currently on the air and to a broadcasting presentation unit to which the service belongs.

The communication interface 9 is connected to the wireless router 10 through a wired LAN 122 or a wireless LAN. Moreover, in addition to or in place of communication functions with the wireless router 10, the communication interface 9 may be designed to directly communicate with external devices by a method including a wireless LAN such as Wi-Fi (registered trademark), IrDA (registered trademark), Bluetooth (registered trademark) and NFC (Near Field Communication) without using the wireless router 10.

The communication interface 9 may be mounted as chips each handling different communication methods. Moreover, the communication interface 9 may be mounted as a single chip handling a plurality of communication methods. Although an example in which the communication interface 9 transmits and receives various types of information to and from the television receiver 19 and the wireless terminal 12 through the wireless router 10 will be described below, the communication interface 9 may directly transmit and receive the various types of information without using the wireless router 10 as described above.

Moreover, the communication interface 9 can transmit and receive various types of information to and from a device connected to an external network through the wireless router 10. For example, it can receive the content stream (video audio stream) in the format of video-on-demand such as the IP broadcasting and the IPTV service from the server connected to the external network. It is also possible to download the video stream and the application program from the server connected to the external network. The downloaded information is stored in, for example, the storage 23.

The signal separation unit 3 separates the transport stream obtained from the tuner-demodulator unit 2 and the content stream obtained through the communication interface 9 for each type into video data, audio data, caption data and program information data. Also, the signal separation unit 3 has a function of obtaining the program information (for example, service information SI) so as to be transmitted to the other processing block. In response to reception of the data transmission request from the other processing unit, the unit transmits the designated data to the requestor.

The audio decoder unit 39 decodes the audio data separated by the signal separation unit 3. The audio information decoded by the audio decoder unit 39 is output from the speaker 41. The audio information decoded by the audio decoder unit 39 may be output to the external equipment from the audio output unit 42. The video decoder unit 40 decodes the video data separated by the signal separation unit 3. The video information decoded by the video decoder unit 40 is transmitted to the superimposing unit 7.

The superimposing unit 7 superimposes the EPG (Electronic Program Guide) image data produced by the function unit for various programs, the OSD (On Screen Display) image data, and images derived from various types of information (caption information, subtitles, data broadcasting data and the like) separated by the signal separation unit 3 on the decoded video information transmitted from the video decoder unit 40. The superimposing unit 7 synthesizes the browser display screen produced by a browser engine 1008 described later and the video signals, or selectively switches therebetween. The video information via the superimposing unit 7 is displayed on the display unit 8.

The display unit 8 is formed of, for example, a display or a liquid crystal panel for the TV and personal computer for displaying the broadcasted/distributed video images, UI for various operations, a browser display screen produced by a browser engine 1008 described later, and images stored in the storage 23. The video information via the superimposing unit 7 may be output to the external equipment from the video output unit 43. The images and video data to be displayed may be the image produced by the application program, image and video data of the contents received via the tuner-demodulator unit 2, those received from the server on the external network 11 via the communication interface 9, and those received from the wireless terminal 12 via the communication interface 9.

Moreover, a digital interface 44 may be provided to allow the signal separation unit 3 to separate the transport stream with respect to a predetermined program for outputting video and audio data without decoding. Since the configurations of the respective units of the television receiver 19 are the same as those of the television receiver 1, the descriptions thereof will be omitted. Moreover, in this embodiment, an example of using a television receiver is described, but the present embodiment can be realized by using a recorder while omitting the display unit and the speaker and presenting the same video and audio data on a television receiver, a display and a speaker connected externally. Furthermore, in the description of the present embodiment, a reference numeral 1 denotes the television receiver, but this may be replaced with an STB, a recorder or the like, and in this case, the speaker 41 and the display unit 8 can be omitted from the configuration of the television receiver shown in FIG. 2.

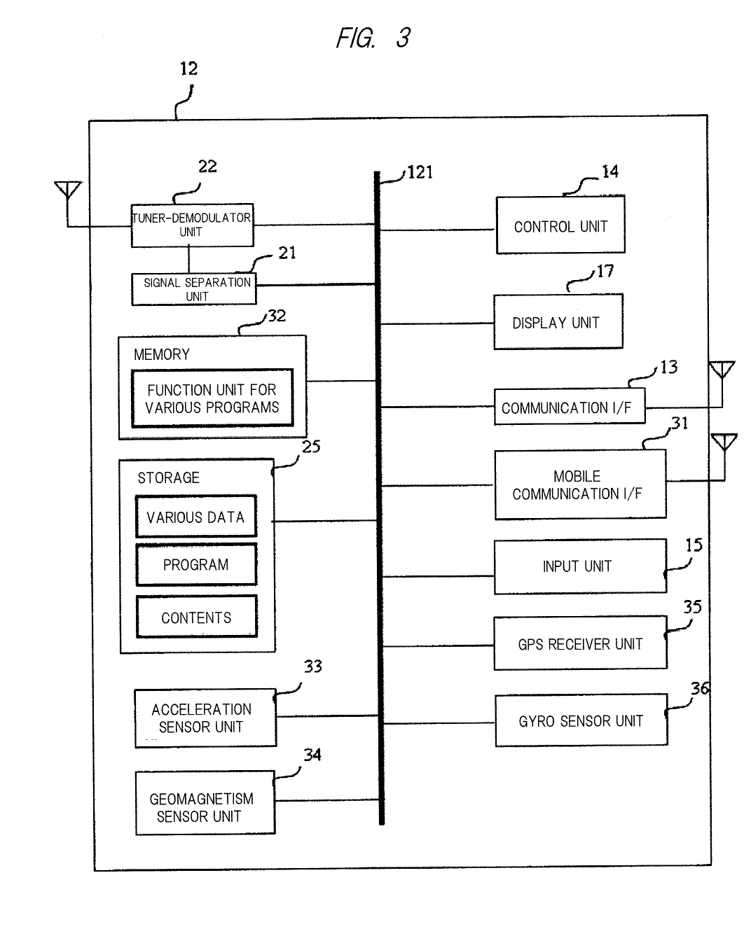

FIG. 3 is a diagram showing a configuration example of the wireless terminal 12. The wireless terminal 12 includes, for example, a communication interface 13, a control unit 14, a display unit 17, an input unit 15, a signal separation unit 21, a tuner-demodulator unit 22, a storage 25, a mobile communication interface 31, a memory 32, an acceleration sensor unit 33, a geomagnetism sensor unit 34, a GPS receiver unit 35 and a gyro sensor unit 36, and the respective processing units are connected to one another through a bus 121.

Moreover, the wireless terminal 12 stores the application program in the storage 25, and the control unit 14, which is made up of an operation unit such as a CPU (Central Processing Unit), loads the program into the memory 32 from the storage 25 and carries out operations in accordance with the programs, thereby realizing the respective functions. For the sake of simplification, the following description will be made on the assumption that various functions realized by carrying out operations in accordance with each of application programs by the control unit 14 are realized mainly by the function unit for various programs.

Note that the application programs may be preliminarily stored in the storage 25 before the shipment of the wireless terminal 12, or may be stored in a medium including an optical medium such as a CD (Compact Disk) or a DVD (Digital Versatile Disk) and a semiconductor memory and installed in the wireless terminal 12 through a medium connection unit (not shown). Moreover, the programs may be downloaded and installed from the external network 11 through the communication interface 13 and the wireless router 10. Alternatively, these may be downloaded and installed from a distributor by way of the base station 18 through the mobile communication interface 31. Furthermore, the programs may be installed by connecting to a personal computer (PC), which has acquired the application programs through the network, via an external device connection interface (not shown) and by moving or copying the programs to the wireless terminal 12 from the PC.

Furthermore, the application programs may be realized by hardware as processing units having the same functions. In the case where the programs are realized by hardware, the respective functions are realized mainly by the respective processing units. The communication interface 13 is connected to the wireless router 10 by a wireless LAN or the like. In addition to or in place of communication functions with the wireless router 10, the communication interface 13 can directly communicate with external devices such as the television receiver 1 or the television receiver 19 by a method including a wireless LAN such as Wi-Fi (registered trademark), IrDA (registered trademark), Bluetooth (registered trademark) and NFC (Near Field Communication) without using the wireless router 10.

The communication interface 13 transmits and receives various types of information to and from the communication interface 9 of the television receiver 1. Moreover, the communication interface 13 is connected to an external network through the wireless router 10, and transmits and receives information to and from a Web server 99 or the like on the external network and receives contents therefrom. The communication interface may be mounted as chips each handling different communication methods. Moreover, the communication interface may be mounted as a single chip handling a plurality of communication methods. The mobile communication interface 31 is connected to a communication network through the base station 18 by utilizing a third generation mobile communication system (hereinafter, referred to as “3G”) such as a GSM (Global System for Mobile Communications) (registered trademark) system, a W-CDMA (Wideband Code Division Multiple Access) (registered trademark) system, a CDMA2000 system or a UMTS (Universal Mobile Telecommunications System) or a mobile communication network such as an LTE (Long Term Evolution) system, and the mobile communication interface 31 can transmit and receive information to and from a server on the communication network.

The control unit 14 receives an operation request of the user through the input unit 15, and controls the signal separation unit 21, the display unit 17, the communication interface 13 and the function unit for various programs. Moreover, the control unit 14 has a function capable of acquiring various types of information and contents from the external network 11 by way of the communication interface 13 and the wireless router 10 or from the external network 11 by way of the mobile communication interface 31 and the base station 18 and transferring them to the function unit for various programs.

The storage 25 is controlled by the instruction from the control unit 14 and can store the application programs. Moreover, the storage 25 stores various types of information produced by the application programs. Furthermore, contents such as video audio streams derived from the signals received through the tuner-demodulator unit 22 and the communication interface 13 or the mobile communication interface 31 may be stored therein. The memory 32 is controlled by the instruction from the control unit 14. The function units of the application programs stored in the storage 25 are loaded into the memory 32 by the control unit 14.

The display unit 17 displays an image and a video image stored in the storage 25, the broadcasted/distributed video images, UI (User Interface) for carrying out various operations, a browser display screen produced by the browser engine 1108 to be described later, and the like. The image and video image to be displayed may be images produced by the application programs, images or video images of contents received through the tuner-demodulator unit 22, images or video images received from a server on the external network through the communication interface 13, images or video images received from the television receiver 1 through the communication interface 13, or images or video images distributed from a server on the communication network through the mobile communication interface 31. Moreover, the display unit 17 may be formed as, for example, an integral unit combined with a touch panel or the like to be described below.

The input unit 15 is an input device that receives the input operation to the wireless terminal 12 by the user and inputs control information relating to the input operation, and may be formed as a physical button and the touch panel. In the following description of this embodiment, an example of using the touch panel will be described, but the respective operations may be performed through the physical buttons.

In the case where the touch panel is employed, a desired object (icon) on the touch panel can be freely moved by an operation (dragging operation) of moving the object while being kept touched with a finger or an operation (flicking operation) of moving the object in a manner of flicking it by a finger on the screen. Moreover, by carrying out an operation (tapping operation) of tapping the object once or an operation (double tapping operation) of tapping the object twice, the object (icon) or the like can be activated or a screen can be switched to another screen.

Also, the screen of the Web contents may be moved freely by the operation of moving any position on the Web contents while being kept touched with the finger (dragging operation). The desired Web contents may be accessed on the browser by the operation of tapping the anchor tag designated with the URL (Uniform Resource Locator) of the linked information of the destination with the finger once (tapping operation). In the description of this embodiment, the above-mentioned respective operations of the touch panel are referred to as “dragging operation”, “flicking operation” and “tapping operation”.

The tuner-demodulator unit 22 and the signal separation unit 21 have the same functions as those of the tuner-demodulator unit 2 and the signal separation unit 3 of the television receiver 1. Since the functions of these have already been described, the descriptions thereof will be omitted. The acceleration sensor unit 33 measures acceleration applied to the wireless terminal 12. The control unit 14 is capable of clarifying the upper part of the wireless terminal 12 by allowing the acceleration sensor unit 33 to measure the gravitational acceleration, and the upper part of the screen to be displayed on the display unit 17 is displayed so as to be aligned with the upper part measured by the acceleration sensor unit 33, so that it is possible to display the screen adapted to that of the wireless terminal 12 held by the user.

The geomagnetism sensor unit 34 measures geomagnetism by utilizing, for example, a plurality of magnetic sensors. The GPS receiver unit 35 receives signals transmitted from a plurality of satellites by utilizing GPS (Global Positioning System). The control unit 14 can calculate the positional information of the wireless terminal 12 based on the signals received by the GPS receiver unit 35. The gyro sensor unit 36 measures the angular velocity of the wireless terminal 12 generated when it is moved by the user.

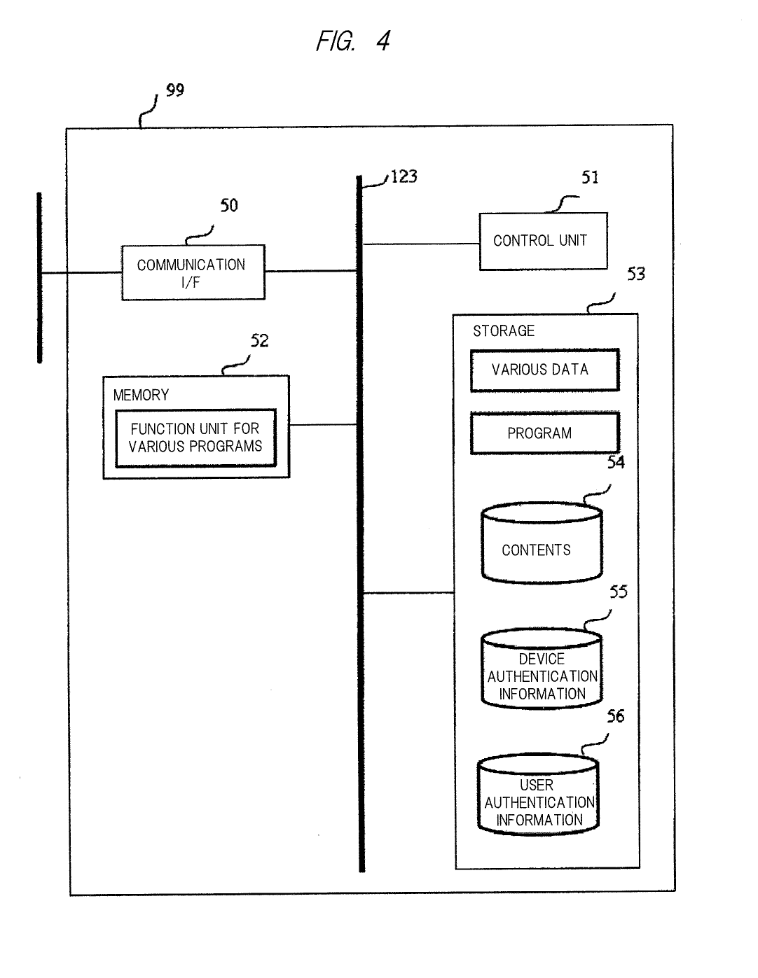

FIG. 4 is a diagram showing a configuration example of the content distribution server 99. The program related distribution server 99 is made up of, for example, a communication interface 50, a control unit 51, a memory 52 and a storage 53, and the respective processing units are connected to one another through a bus 123. Moreover, the content distribution server 99 stores the application programs in the storage 53, and the control unit 51 can realize various functions by loading the above-mentioned program from the storage 53 into the memory 52 and carrying out operations in accordance with the program. For the sake of simplification, the following description will be made on the assumption that various functions realized by carrying out operations in accordance with each of application programs by the control unit 51 are realized mainly by the function unit for various programs.

The communication interface 50 is connected to the external network 11 and further connected to the wireless router through the external network 11. The communication interface 50 transmits and receives various types of information to and from the communication interface 9 of the television receiver 1 or the communication interface 13 of the wireless terminal 12. The control unit 51 controls the communication interface 50, the memory 52, the storage 53 and the function unit for various programs. Moreover, the control unit 51 also has a function of transferring contents accumulated in the contents 54 of the storage 53 to the television receiver 1 or the wireless terminal 12 through the communication interface 50 and the external network 11.

The storage 53 is controlled by the instruction from the control unit 51 and can store the application programs. Moreover, the storage 53 stores various types of information produced by the application programs. Also, it further has a function of accumulating contents, device authentication information, user management information and the like. The memory 52 is controlled by the instruction from the control unit 51. The function units of the application programs stored in the storage 53 are loaded into the memory 52 by the control unit 51.

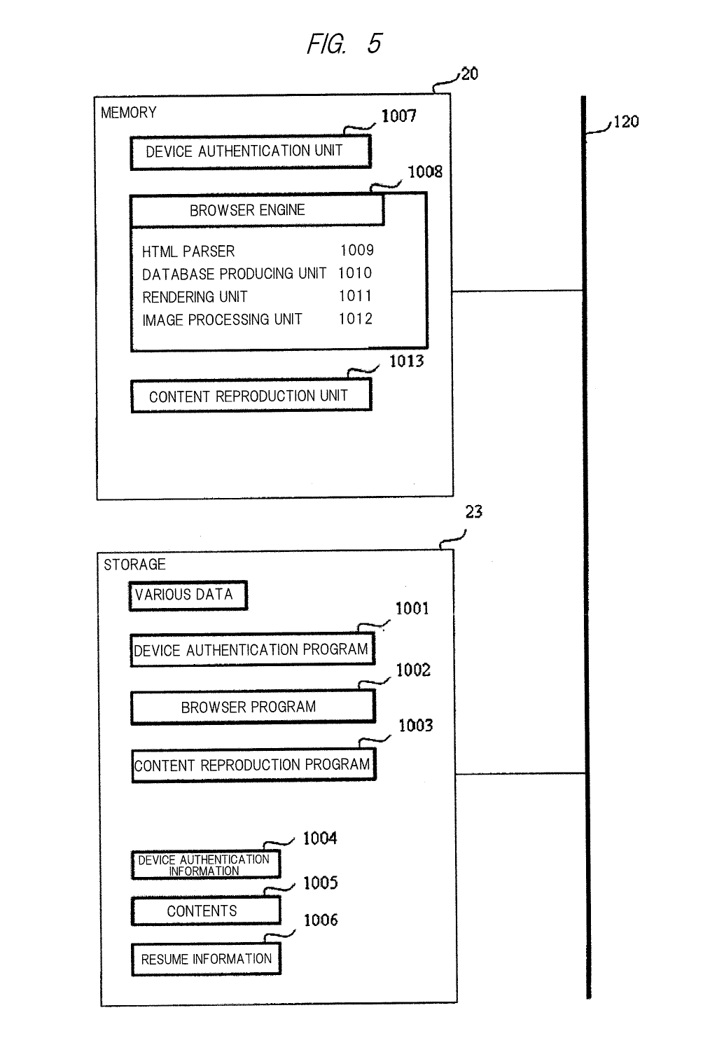

FIG. 5 is a diagram showing an example of information to be stored in the storage 23 and the memory 20 in the configuration of the television receiver 1 shown in FIG. 2. As shown in FIG. 5, the storage 23 stores a device authentication program 1001, a browser program 1002 and a content reproduction program 1003. When the control unit 5 loads these programs into the memory 20, a device authentication unit 1007, a browser engine 1008 and a content reproduction unit 1013 are configured in the memory 20. The device authentication program 1001, the browser program 1002 and the content reproduction program 1003 may be stored in the storage 23 at the time of the shipment of the product, or may be downloaded through the communication interface 9.

For the sake of simplification, the following description will be made on the assumption that various functions realized by carrying out operations in accordance with each of application programs by the control unit 5 are realized mainly by the function unit for various programs.

In the television receiver 1, device authentication information such as a user ID, a password and a device ID which has been set by the user through inputs by the use of the input unit 4 or preliminarily set before the shipment from the factory of the television receiver 1 is stored in device authentication information 1004 of the storage 23. It is assumed that the device authentication unit 1007 is allowed to refer to the device authentication information in the device authentication. Moreover, it is assumed that the above-mentioned device authentication information is displayed on the display unit 8 by an operation by the user or the user is allowed to confirm the device authentication information in reference to the document attached to the television receiver 1 at the time of purchasing.

The device authentication unit 1007 compares the device authentication information stored in the device authentication information 1004 with device authentication information transmitted from the wireless terminal 12, and if they match with each other, the connection of the wireless terminal 12 is permitted, and the user ID, the password and the device ID received from the wireless terminal 12 are stored in the device authentication information 1004 as personal authentication information and are referred to when needed. On the other hand, when the device authentication information is incorrect, the device authentication unit 1007 does not authenticate the connection from the wireless terminal 12.

In this case, the device authentication information transmitted from the wireless terminal 12 corresponds to information input through the wireless terminal 12 by the user who operates the wireless terminal 12. The user carries out an authentication process for operating the television receiver 1 through the wireless terminal 12 by inputting the device authentication information displayed on the display unit 8 or confirmed on the attached document as described above to the wireless terminal 12.

The above-mentioned process is one example of the authentication method, and when connecting the television receiver 1 and the wireless terminal 12 through the wireless LAN, any known techniques such as the authentication/encoding method using the SSID (Service Set Identifier) and WEP (Wired Equivalent Privacy) key or WPS (Wi-Fi Protected Setup) key may be employed as the authentication method and the encoding method of the information transmitted and received at the success of the authentication, and the method is not particularly limited in this embodiment.

Moreover, the device authentication unit 1007 has a function of transmitting the device authentication information stored in the device authentication information 1104 to a user management unit 1208 of the content distribution server 99 to be described later byway of the communication interface 9 and the wireless router 10. Furthermore, the device authentication information transmitted to the content distribution server 99 can be separately managed as the information that is associated with the device authentication information of the connection device to the wireless terminal 12 and can be recognized by the content distribution server 99.

As shown in FIG. 5, the browser engine 1008 is made up of respective function blocks such as an HTML (HyperText Markup Language) parser 1009, a database producing unit 1010, a rendering unit 1011 and an image processing unit 1012. The HTML parser 1009 analyzes a logical structure of HTML data acquired through the network control unit and the control unit 5. Moreover, the HTML parser 1009 can interpret the acquired HTML data and convert the HTML data into inner data to be used in the television receiver 1. The database producing unit 1010 produces database relating to the HTML data structure. The rendering unit 1011 produces the layout structure that contains information in the expression format defined by each tag based on the database, and further produces the browser display screen just in accordance with the data having the size, position and image imported based on the layout structure. The image processing unit 1012 converts the obtained image file into the image data in the bitmap format and the like based on the image file information such as the position of the image file and the image file name designated with the image tag in the HTML data.

The content reproduction unit 1013 receives content data (for example, movie, drama and others) and content information distributed from the content distribution server 99 by way of the external network 11, and successively reproduces the received video data, audio data and others, thereby presenting them to the user.

In the present embodiment, the case of the distribution and reproduction of contents by streaming will be described, but as in the case of the embodiments to be described later, it is also possible to preliminarily acquire and accumulate all the content data from the server, and view and reproduce the contents after the completion of the accumulation. In this case, the content data are stored in the contents 1005 of the storage 23. Moreover, information relating to a reproduction stop position of content is stored in resume information 1006 of the storage 23, and when the reproduction of the same content is resumed, the data of the reproduction stop position is acquired from the resume information 1006 and the reproduction start position is determined.

FIG. 6 is a diagram showing an example of information to be stored in the storage 25 and the memory 32 in the configuration of the wireless terminal 12 in FIG. 3. As shown in FIG. 6, the storage 25 stores a device authentication program 1101, a browser program 1102 and a content reproduction program 1103. When the control unit 14 loads these programs into the memory 20, a device authentication unit 1107, a browser engine 1108 and a content reproduction unit 1113 are configured in the memory 20. More specifically, the device authentication program 1101, the browser program 1102 and the content reproduction program 1103 are used as wireless operation controlling programs. The device authentication program 1101, the browser program 1102 and the content reproduction program 1103 may be stored in the storage 25 at the time of the shipment of the product, or may be downloaded through the communication interface 13 or the mobile communication interface 31.

For the sake of simplification, the following description will be made on the assumption that various functions realized by carrying out operations in accordance with each of application programs by the control unit 14 are realized mainly by the function unit for various programs.

In order to receive an authentication from the television receiver 1, the device authentication unit 1107 transmits device authentication information of a connection device such as a user ID, password and a device ID preliminarily registered in the device authentication information 1104 through inputs by the use of the input unit 15 by the user to the device authentication unit 1007 of the television receiver 1 by way of the communication interface 13 and the wireless router 10. Moreover, in the case of the second and subsequent authentications, the input of the authentication information may be omitted by reference to the device authentication information of the connection device registered in the device authentication information 1104 of the storage 25.

Furthermore, the device authentication unit 1107 has also a function of transmitting the device authentication information stored in the device authentication information 1104 to the user management unit 1208 of the content distribution server 99 by way of the communication interface 13 or the mobile communication interface 31 as the device authentication information of the content distribution destination. Moreover, the device authentication information of the content distribution destination can be separately managed as the information that is associated with the device authentication information of the connection device and can be recognized by the content distribution server 99.

The browser engine 1108 is made up of respective function blocks including an HTML parser 1109, a database producing unit 1110, a rendering unit 1111 and an image processing unit 1112 like the browser engine 1008 of the television receiver 1. Since the HTML parser 1109, the database producing unit 1110, the rendering unit 1111 and the image processing unit 1112 are the same as those of the browser engine 1008, the detailed descriptions thereof will be omitted.

The content reproduction unit 1113 receives content data (for example, movie, drama and others) and content information distributed from the content distribution server 99 by way of the external network 11 or the mobile communication interface 31, and successively reproduces the received video data, audio data and others, thereby presenting them to the user. In the present embodiment, the case of the distribution and reproduction of contents by streaming will be described, but as in the case of the embodiments to be described later, it is also possible to preliminarily acquire and accumulate all the content data from the server, and view and reproduce the contents after the completion of the accumulation. In this case, the content data are stored in the contents 1105 of the storage 23. Moreover, information relating to a reproduction stop position of content is stored in resume information 1106 of the storage 25, and when the reproduction of the same content is resumed, the data of the reproduction stop position is acquired from the resume information 1106 and the reproduction start position is determined.

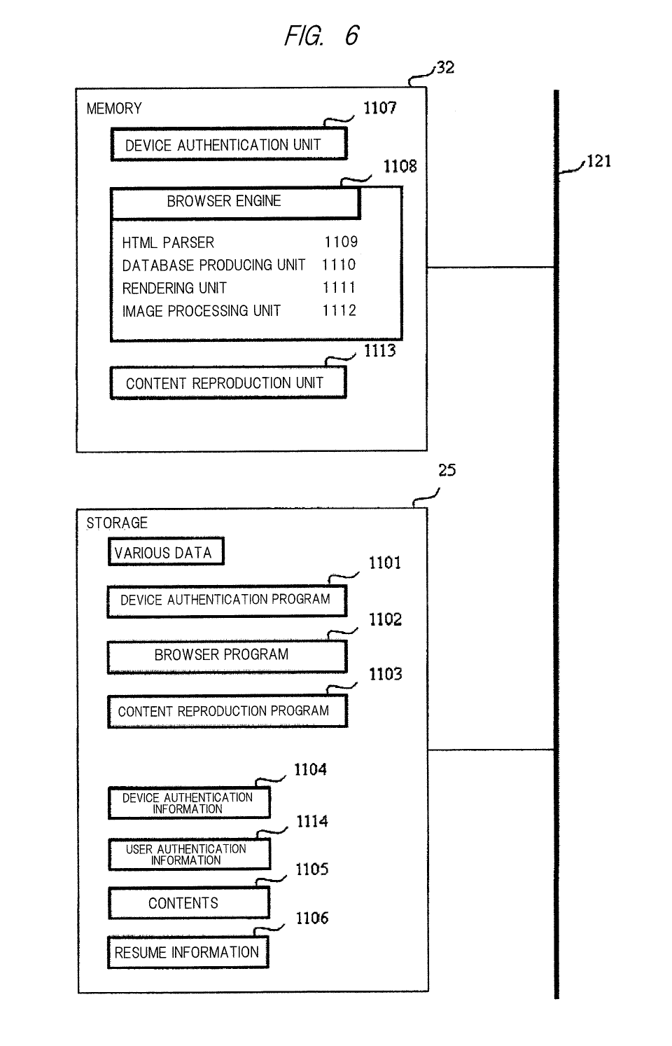

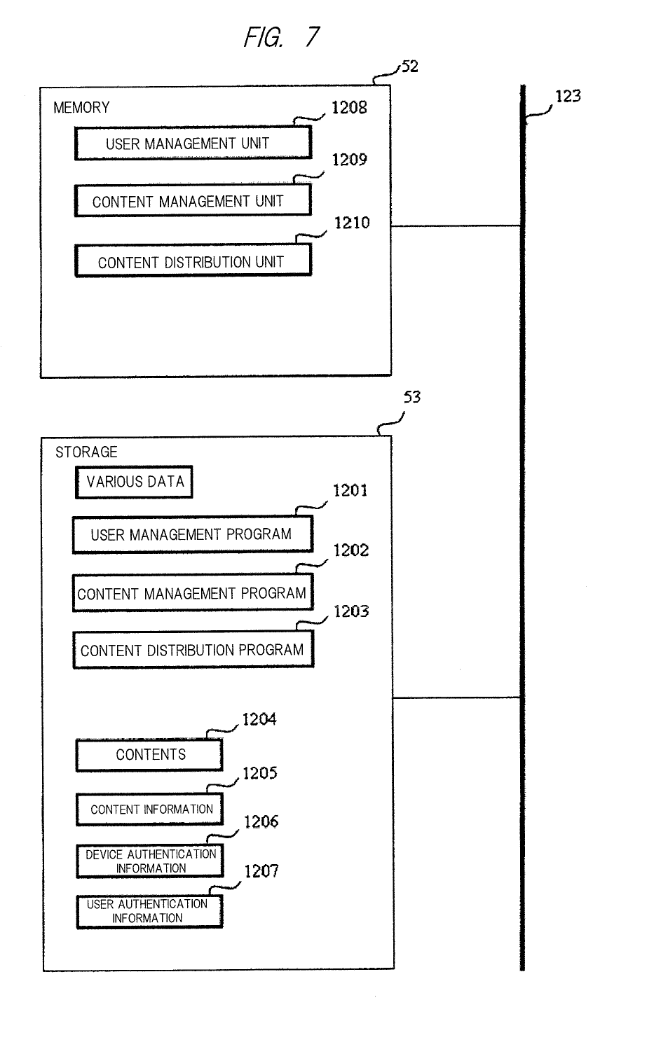

FIG. 7 is a diagram showing an example of information to be stored in the storage 53 and the memory 52 of the configuration of the content distribution server 99 in FIG. 4. As shown in FIG. 4, the storage 53 stores a user management program 1201, a content management program 1202 and a content distribution program 1203. When the control unit 51 loads these programs into the memory 20, a user management unit 1208, a content management unit 1209 and a content distribution management unit 1210 are configured in the memory 20. The user management program 1201, the content management program 1202 and the content distribution program 1203 may be preliminarily stored from an external storage or the like.

For the sake of simplification, the following description will be made on the assumption that various functions realized by carrying out operations in accordance with each of application programs by the control unit 51 are realized mainly by the function unit for various programs.

The user management unit 1208 manages user authentication information for carrying out the authentication for each user, device authentication information for authenticating a device possessed by the user, and the like. The user authentication information and the device authentication information are stored in the user authentication information 1207 and the device authentication information 1206 of the storage 53, respectively. The user management unit 1208 acquires user authentication information such as a user name and password and device authentication information of a device used by the user input through inputs using the input unit 4 or the input unit 15 by the user of the wireless terminal 12 and the television receiver 1 via the communication interface 50 and the external network 11, and confirms whether or not the user is an authorized registered user and whether or not the device possessed by the user is within the number of devices permitted for the same user by the service provider. The user management unit 1208 has a function of returning error information if the user authentication information is not correct or if the permitted number of devices is exceeded.

The content management unit 1209 manages content information composed of content data and attached information. The content information records a content ID (management number) for uniquely identifying the contents, a content format, content explanatory information (genre, title, cast, story, etc.), content data, content size, target device suitable for display, fees charged for content distribution service or viewing and reproduction of the distributed contents, viewing period, and the like.

Note that these various types of information may be recorded by using a recording medium such as a hard disk, and read into a memory managed by the content management unit. Moreover, these may be managed by separating them into some portions such as content data, data for explaining the content data (meta-data), and the like. It is also possible to manage the key information which is used for decrypting and reproducing contents encoded by using an RSA (Rivest Shamir Adleman) encryption technique for the purpose of protection from a malevolent third party on a communication path of the Internet. Note that these various types of information may be recorded by using a recording medium such as a hard disk and read into a memory managed by the content management unit 1209.

The content distribution unit 1210 can control the distribution of the contents accumulated in the contents 54 of the storage 53 in accordance with the display performances of the connection device based on a distribution request from a device such as the wireless terminal 12 and the television receiver 1 through the communication interface 50 and the external network 11. In the present embodiment, the contents 54 have the same contents with different resolutions, and distribute the contents suitable for the display performance based on the device authentication information at the time of distribution. Note that it is also possible to accumulate only high-quality (HD) contents and down-convert the contents in accordance with the display performance at the time of the distribution.

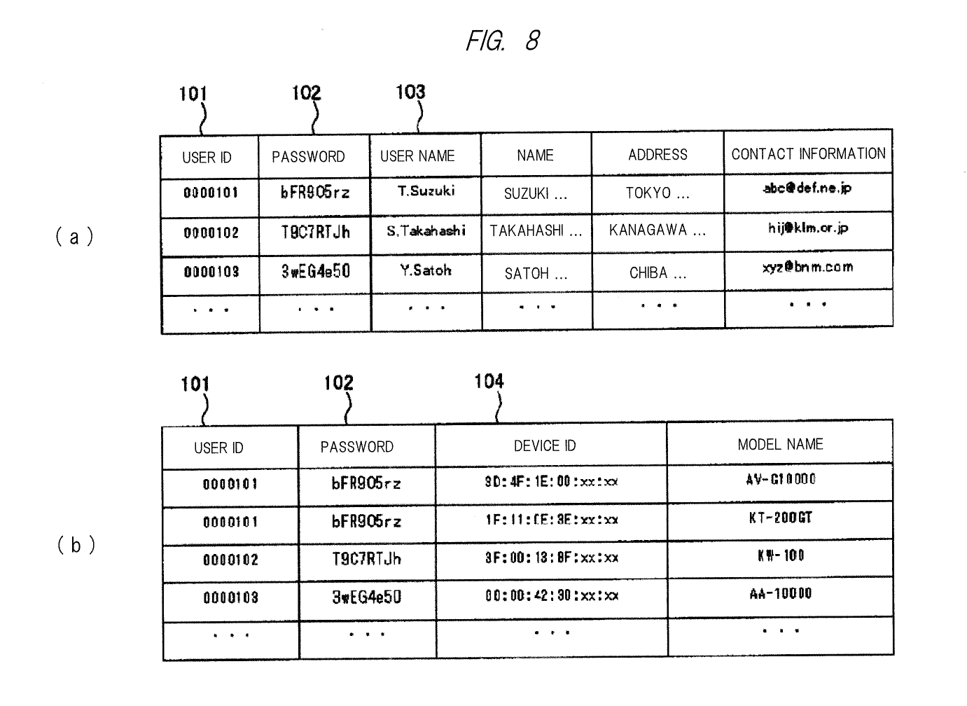

FIG. 8(a) is a diagram showing a data table representing an example of contents of the user authentication information 1207 to be managed by the user management unit 1208 of the content distribution server 99. The user authentication information 1207 managed by the user management unit 1208 stores a user ID (management number) 101, a password 102, a unique user name 103, name and address, contact information, and the like. Although the present embodiment will be described based on the premise of the user authentication by the password, general biological authentications using finger veins, fingerprints, voice, facial image, iris, or the like may be used, and in this case, items of the user authentication information are appropriately changed.

FIG. 8(b) is a diagram showing a data table representing an example of contents of the device authentication information 1206 to be managed by the user management unit 1208 of the content distribution server 99. The device authentication information 1206 includes a user ID (management number) 101, a password 102, a device ID 104 indicating a device used by the user, a model name, and the like, and it is the information for uniquely identifying the device. In the present embodiment, the user whose user ID 101 corresponds to “0000101” has two devices indicated by device ID 104. Moreover, the password that is different from the password of the user authentication information may be used as the password 102. Furthermore, information inherent to the device such as MAC (Media Access Control) address or the like may be used as the device ID 104. Also, distinctions of the kinds of reproducible contents, resource information of video processing capability and the like may be preliminarily accumulated as database in association with the device ID.

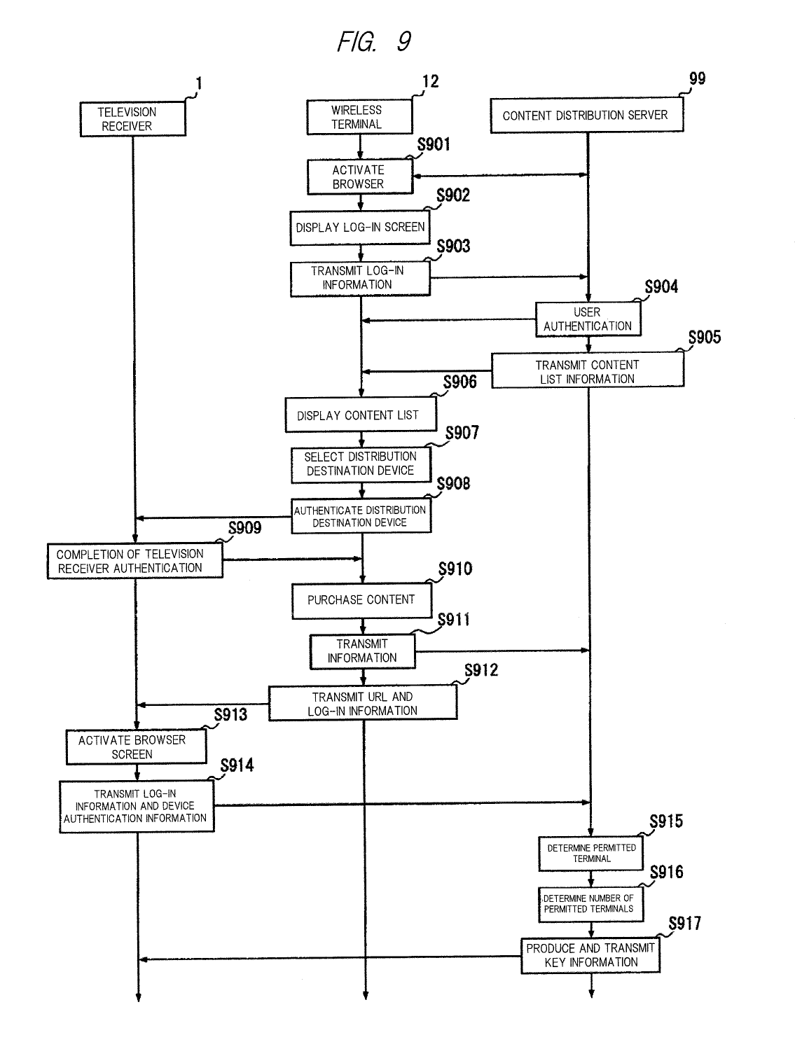

Referring to FIG. 9, the operations of the system in the present embodiment will be described. FIG. 9 is a diagram showing one example of an operation sequence relating to the present embodiment. FIG. 9 is a sequence diagram showing operations before the start of exchange of content information between the television receiver 1 and the content distribution server 99 in the case where the wireless terminal 12 is used as the operation terminal, contents are distributed from the content distribution server 99 to the television receiver 1, and the contents are displayed on the television receiver 1.

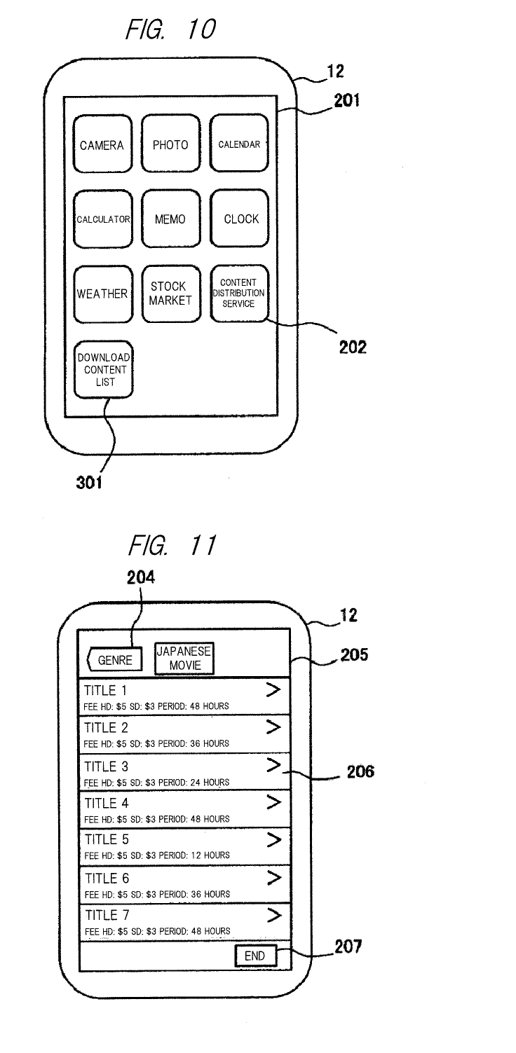

FIG. 10 is a diagram showing a display example of a menu screen of the wireless terminal 12. As shown in FIG. 10, when an icon 202 “content distribution service” of a menu screen 201 is tapped, the control unit 14 of the wireless terminal 12 receives an instruction for activating a browser from the input unit 15, and activates the browser engine 1108 (S901). The browser engine 1108 makes an access to the content distribution server 99 of a predetermined content viewing portal.

Next, the browser engine 1108 transmits a request message for requesting a resource such as Web contents in compliance with HTTP (HyperText Transfer Protocol) to the content distribution server 99 from the external network 11 by way of the control unit 14, the communication interface 13 and the wireless router 10. The content distribution server 99 produces a response message in accordance with the received request message and returns the message. The response message thus returned is input to the browser engine 1108 via the external network 11. An HTML document is embedded in the response message. The HTML parser 1109, the database producing unit 1110, the rendering unit 1111 and the image processing unit 1112 of the browser engine 1108 are operated in cooperation with one another to function as a login screen display unit, so that a browser display screen is produced based on the HTML document and a login screen of the content viewing portal is displayed on the display unit 17 (S902).

On the login screen displayed by the above-mentioned processes, the control unit 14 notifies the browser engine 1108 of login information including a user name and a password input by the input unit 15, and transmits a received character string to the content distribution server 99 as a request message (S903). The content distribution server 99 refers to the user authentication information 1207 by the user management unit 1208, and authenticates the user if the user is an authorized registered user (S904) and stores the authenticated login information in the user authentication information 114 of the storage 25.

Upon completion of the authentication of S904, the content management unit 1209 of the authentication content distribution server 99 returns content list information to the browser engine 1108 as a response message (5905). The content list information transmitted herein is information for displaying a list of contents managed in the content management unit 1209. Upon receipt of the content list information from the content management unit 1209, the browser engine 1108 refers to a content ID for uniquely identifying the content, content explanatory information (genre, title, cast, story, etc.), fees charged when viewing and reproducing the content, a viewing period, and the like contained therein, and displays a content list display screen as shown in FIG. 11 on the display unit 17 (S906). More specifically, in S906, the browser engine 1108 functions as a content selection screen display unit. FIG. 11 is a diagram showing a display example of the content list display screen of the wireless terminal 12.

In FIG. 11, a content title display 205 displays a content title name, a viewing fee, a viewing period, and others. Moreover, a “back” button 204 is a button for returning to an upper hierarchy by a tapping operation, and allows to return to the previous hierarchy of genre selection. The example of FIG. 11 indicates that “Japanese Movie” 203 in the movie genre is selected. An “end” button 207 is an operation unit for instructing to stop viewing the content by a tapping operation.

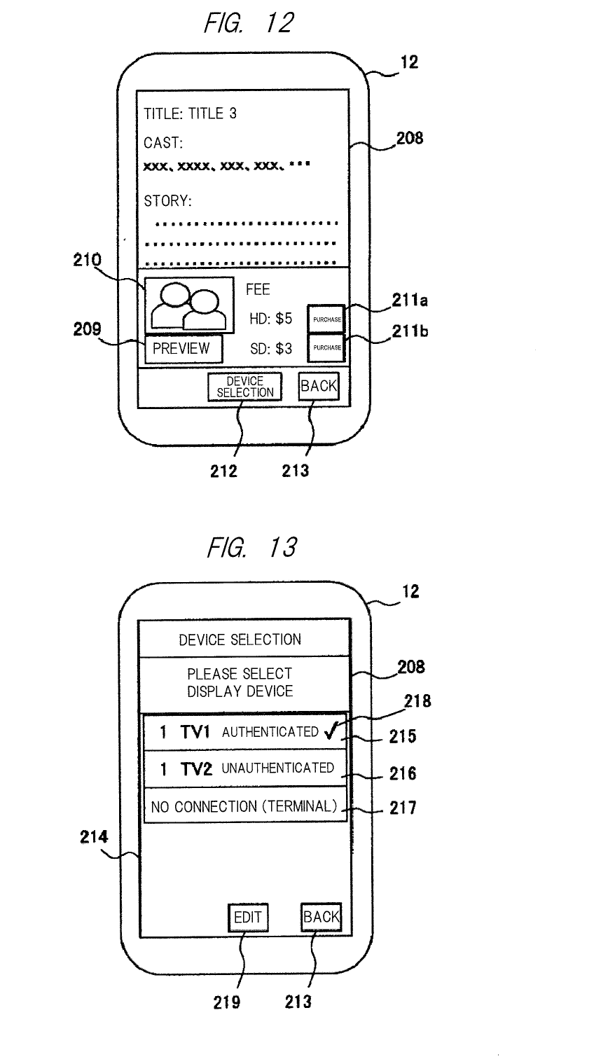

In the screen shown in FIG. 11, when a title 206 of the content desired to be viewed is selected on the content list display screen by the input unit 15, a content detail display screen shown in FIG. 12 is displayed. FIG. 12 is a diagram showing a display example of the content detail display screen of the wireless terminal 12. In FIG. 12, a content detail unit 208 displays a title, performers, detailed contents, and the like. A “preview” button 209 is an operation unit for instructing the display of a part of the content so as to confirm the content prior to purchasing the content. An index screen 210 is a stationary image representing one scene of the content.

“Purchase” buttons 211a and 211b are operation units for selecting and purchasing the content. In the example of FIG. 12, in order to select and purchase respective contents having HD (High Definition) quality and SD (Standard Definition) quality, the “purchase” buttons 211a and 211b associated therewith are provided. A “device selection” button 212 is an operation unit for specifying the distribution destination of the purchased content, thereby selecting the device to display the content. A “back” button 213 is an operation unit for returning to the content list display screen of FIG. 12, that is, for instructing to switch the display to the content list display screen.

Next, when the “device selection” button 213 is selected by the input unit 15 so as to select a device specified as the distribution destination prior to the purchasing content, a connection device list display screen as shown in FIG. 13 is displayed on the display unit 17. The display of this connection device list display screen is also executed by the browser engine 1108. More specifically, in this case, the browser engine 1108 functions as a device selection screen display unit. FIG. 13 is a diagram showing a display example of the connection device list display screen of the wireless terminal 12. In FIG. 13, when any device connected to the network is found, the device is displayed on a device selection list 214 regardless of whether it is authenticated or unauthenticated, and the device thus found is stored in the storage 25 together with the information of being authenticated or unauthenticated.

In the present embodiment, a “TV1 (television receiver 1) display” 215, a “TV2 (television receiver 2) display” 216 and a “no connection (terminal)” 217 are displayed on the device selection list 214, and the “TV1” is indicated as the authenticated device. The “no connection (terminal)” 217 is an item to be selected when a wireless terminal alone is used without the authentication relative to any device.

In the wireless terminal 12, of the devices connected to the network, “authenticated” is displayed with respect to a device that has been authenticated by the device authentication unit 1107, that is, a device whose device ID has been registered in the device authentication information 1104, and “unauthenticated” is displayed with respect to a device that has not been authenticated, that is, a device whose device ID has not been registered as shown in FIG. 13. FIG. 13 shows a display example in the case where the “TV1 (television receiver 1) display” 215 has already been authenticated in the wireless terminal 12. Moreover, a check mark 218 is displayed on a device that is being selected so that the user can distinguish which device is being selected. Furthermore, an “edit” button 219 is a button for deleting a connected device or adding a device to be connected. A “back” button 213 is a button for returning to the content list display screen of FIG. 7.

In FIG. 13, when the device to display the purchased content is selected by the input unit 15 (S907), the device authentication unit 1107 of the wireless terminal 12 transmits the device authentication information preliminarily registered in the device authentication information 1104 to the device authentication unit 1007 of the television receiver 1 by way of the communication interface 13 and the communication interface 9 so as to receive the authentication from the television receiver 1 (S908). In this case, an example in which the television receiver 1 is selected in S907 will be described.

Upon receipt of the device authentication information from the wireless terminal 12, the device authentication unit 1007 of the television receiver 1 compares the authentication information stored in the device authentication information 1004 with the authentication information transmitted from the wireless terminal 12, and if they match with each other, the connection of the wireless terminal 12 is permitted (S909). In the case where no response is received due to the reason that the power supply of the television receiver 1 is not turned on or the like, a power-ON command for activating the power supply of the television receiver 1 may be added in step S908 so as to execute the device authentication again. By the process described above, devices that utilize the television receiver 1 by a remote control operation can be further narrowed down, so that the security can be enhanced.

After the device to display the content is selected and the connection permission is notified from the selected device, when the user operates either one of the “purchase” buttons 211a and 211b by the input unit 15 on the content detail display screen shown in FIG. 12 and the operation content indicating the purchase of the content is notified from the input unit 15 (S910), the control unit 14 transmits the content selection information and the device authentication information of the distribution destination to the content distribution server 99 (S911). More specifically, in S911, the control unit 14 functions as an identification information notifying unit that notifies the content distribution server 99 of the identification information of the device to be used for displaying the content.

Note that the process of S911 is executed by allowing the control unit 14 to carry out operations in accordance with the browser program 1102 and information read by the browser program 1102 like the display process of the content list display screen and the display process of the connection device list display screen described above. By these processes, the device to which the content is to be distributed is notified from the wireless terminal 12 to the content distribution server 99. Note that, in order to prevent unauthorized accesses, the content distribution server 99 may be designed to discard the device authentication information of the distribution destination when a predetermined period of time has elapsed after the receipt of the device authentication information of the distribution destination.

Moreover, the control unit 14 refers to a URL for accessing to the content distribution server 99 and log-in information including a user name and a password for logging in, which is stored in the user authentication information 1114, and transmits them to the television receiver 1 (S912). More specifically, in S912, the control unit 14 functions as a viewing instruction notification unit. Note that the process of S912 is executed by allowing the control unit 14 to carry out operations in accordance with the browser program 1102 and information read by the browser program 1102 like the display process of the content list display screen and the display process of the connection device list display screen described above. When the television receiver 1 acquires an accessing URL and log-in information from the wireless terminal 12, it activates the browser engine 1008 associated with the received URL (S913). In this manner, by notifying the television receiver 1 of log-in information from the wireless terminal 12 serving as a user operation terminal, the television receiver 1 is allowed to log-in the content distribution server 99, so that it is possible to improve the cooperation among the devices.

Next, the television receiver 1 that has activated the browser engine 1008 transmits the log-in information and the device authentication information stored in the device authentication information 1004 to the content distribution server 99 indicated by the URL received from the wireless terminal 12 (S914). Upon receipt of the log-in information and the device authentication information from the television receiver 1, the content distribution server 99 determines whether or not the log-in information and the device authentication information received from the television receiver 1 match with the log-in information and the device authentication information of the distribution destination received from the wireless terminal 12 in step S911 (S915).

In step S915, the content distribution server 99 associates the information received in S911 with the information received in S914 based on the device ID of the wireless terminal 12, and determines whether or not the device authentication information of the distribution destination matches. When the device authentication information does not match as a result of the determination in S915 or the corresponding device authentication information is not received in S911, the content distribution server 99 transmits error information to the television receiver 1. Moreover, in the case where the device authentication information of the distribution destination has been discarded because a predetermined period of time has elapsed after receiving the information in step S911, the processes may be carried out again from step S911.

When the device authentication information matches as a result of the determination in S915, the content distribution server 99 next determines whether or not the number of devices of the distribution destination is within the number of devices permitted by the service provider (S916). In S916, the content distribution server 99 refers to the device authentication information 1206 described in FIG. 8(b), and determines whether or not the number of devices associated with the user ID contained in the log-in information is kept within the permissible range. When the number exceeds the permitted number of devices as a result of the determination, the content distribution server 99 transmits error information to the television receiver 1.

When the number is within the permitted number of devices as a result of the determination in S916, the content distribution server 99 produces key information for decoding the content, and transmits the key information to the television receiver 1 (S917). The processes of S915 to S917 are executed by the content management unit 1209. More specifically, in S915 to S917, the content management unit 1209 functions as a device identification information acquiring unit for acquiring device identification information of the television receiver 1, an information acquiring request receiver unit for receiving an information acquiring request from the television receiver 1 and a device determination unit for determining whether or not information can be provided. The key information includes a content ID for each of the contents, an effective period (or an effective number of times), and the like in addition to a decryption key for decoding information of encoded contents. Note that the transmitting step S917 of the key information is a step carried out when the content need to be encoded, and this step may be omitted when the content do not need to be encoded.

By these processes described above, operations before the television receiver 1 selected as a device to display the contents and the content distribution server 99 start exchanging the content information are completed. According to the process shown in FIG. 9, after preliminarily transmitting the device authentication information of the television receiver 1 to the content distribution server 99, the wireless terminal 12 notifies the television receiver 1 of an URL for distributing the content. For this reason, upon receipt of an access for distributing the content from the television receiver 1, the content distribution server 99 can determine whether or not the access is a correct one based on the device authentication information of the television receiver 1 received from the wireless terminal 12. Therefore, even in the case where the three devices are operated in cooperation with one another, security and copyright management can be ensured.

Note that, by carrying out the sequence shown in FIG. 9, the device selected in S907 is registered in the content distribution server 99 as indicated by the device authentication information 1206 shown in FIG. 8(b). Moreover, the information of the wireless terminal 12 is registered in the television receiver 1. For this reason, in the case where the same user tries to display the content by using the same device (in this case, television receiver 1) next time and later, the processes of S908 and S911 can be omitted. Consequently, the processes can be simplified, so that the reduction of the network load and the faster operation can be achieved.

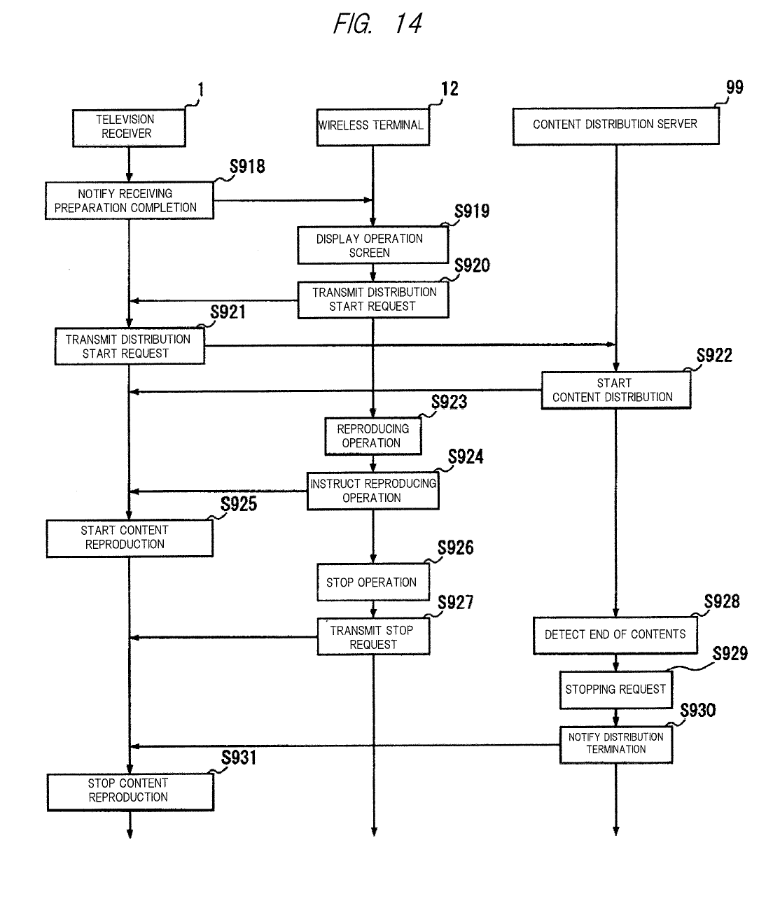

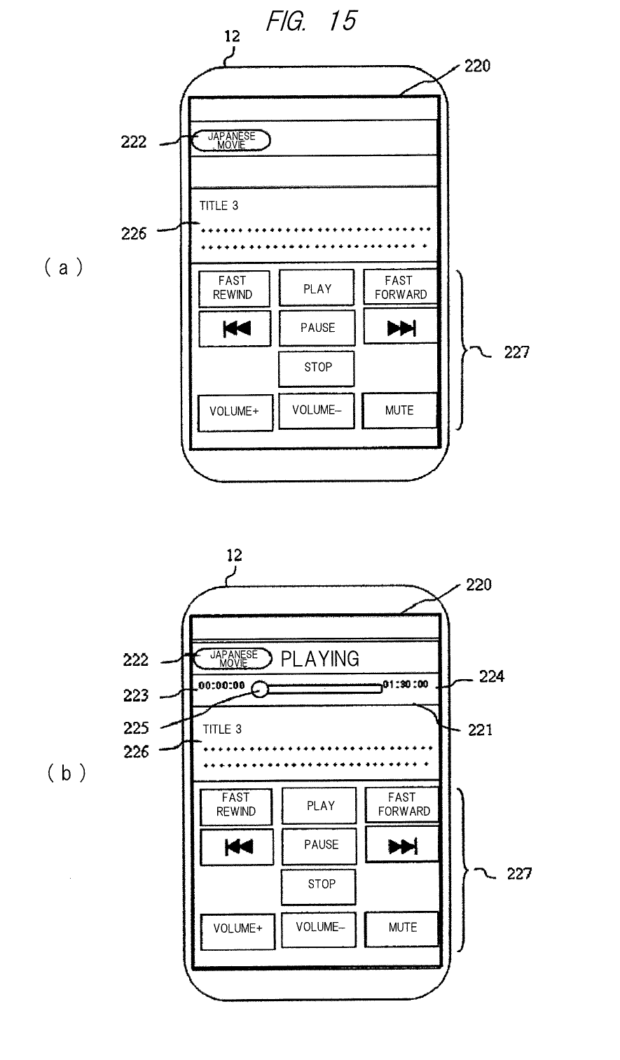

Next, referring to FIG. 14, the operations when the television receiver 1 and the content distribution server 99 exchange the information of the content and the content is displayed on the television receiver 1 will be described. As shown in FIG. 14, the television receiver 1 receives key information from the content distribution server 99, and transmits a receiving preparation completion message to the wireless terminal 12 when preparation for receiving the content is completed (S918). Upon receipt of the receiving preparation completion message from the television receiver 1, the wireless terminal 12 displays an operation screen shown in FIG. 15(a) on the display unit 17 (S919). More specifically, in S919, the control unit 14 executes operations in accordance with the browser program 1102 and information read by the browser program 1102, and consequently functions as an operation screen display unit. Note that, as a program for allowing the control unit 14 to function as the operation screen display unit, a dedicated application program may be used in addition to the above-mentioned browser program 1102.

When the user operates the screen of the wireless terminal 12 shown in FIG. 15, the wireless terminal 12 transmits a distribution start request to the television receiver 1 (S920). More specifically, in S920, the control unit 14 executes operations in accordance with the browser program 1102 and information read by the browser program 1102, and consequently functions as an operation signal output unit. Note that, as a program for allowing the control unit 14 to function as the operation signal output unit, a dedicated application program may be used in addition to the above-mentioned browser program 1102.

Upon receipt of a distribution start request from the wireless terminal 12, the television receiver 1 transmits the distribution start request to the content distribution server 99 (S921). Then, upon receipt of the distribution start request from the television receiver 1, the content distribution server 99 starts the content distribution to the television receiver 1 (S922).

FIGS. 15(a) and 15(b) are diagrams showing a display example of a content operation screen displayed on the wireless terminal 12. As shown in FIG. 15(a), on the content operation screen 220, a genre display unit 222 for displaying genres of the content, a content detail display unit 226 for displaying the detail of the content and an operation display unit 227 are displayed. The operation display unit 227 is an operation unit for allowing the wireless terminal 12 to transmit a content reproduction start instruction to a content reproduction unit 1013 of the television receiver 1, a volume control or muting instruction to the control unit 5 of the television receiver 1 and others.

On the screen shown in FIG. 15(a), when the “PLAY” of the operation display unit 227 is tapped by the user operation through the input unit 15 (S923), the wireless terminal 12 transmits a reproducing operation command to the television receiver 1 (S924). In the television receiver 1 that has received the reproducing operation command, the content reproduction unit 1013 carries out a reproducing process of the content. At this time, in the case where the decryption key is prepared, the information of the encoded content is decoded by using the key, and the reproduction of the content is started (S925).

When the reproduction of the content is started, on the operation screen of the wireless terminal 12, a seek bar 225, a current reproducing time 223 and a length of the content 224 are displayed on a reproducing bar display unit 221 as shown in FIG. 15(b). The seek bar 225 is automatically moved in accordance with the current reproducing position, and the user can operate the seek bar 225 by the dragging operation to change the position thereof, thereby starting the reproduction from the position corresponding to the changed position.

The reproduction start position can be calculated based on the total display width of the seek bar 225, the current dragging position and a ratio of the currently displayed content relative to the total reproduction time. The wireless terminal 12 adds the information of the reproduction start position thus calculated to the reproducing operation command, and notifies the television receiver 1 of the information. According to the information of the reproduction start position received in this manner, the television receiver 1 can alter the reproducing position of the currently reproduced content. When the user taps a button such as a “fast-forward” or “fast-rewind” button displayed on the operation display unit 227, the wireless terminal 12 transmits a reproducing operation command indicating the fast-forwarding, fast-rewinding or the like to the television receiver 1, and the reproducing operation such as the fast-forwarding, fast-rewinding or the like can be carried out on the television receiver 1.

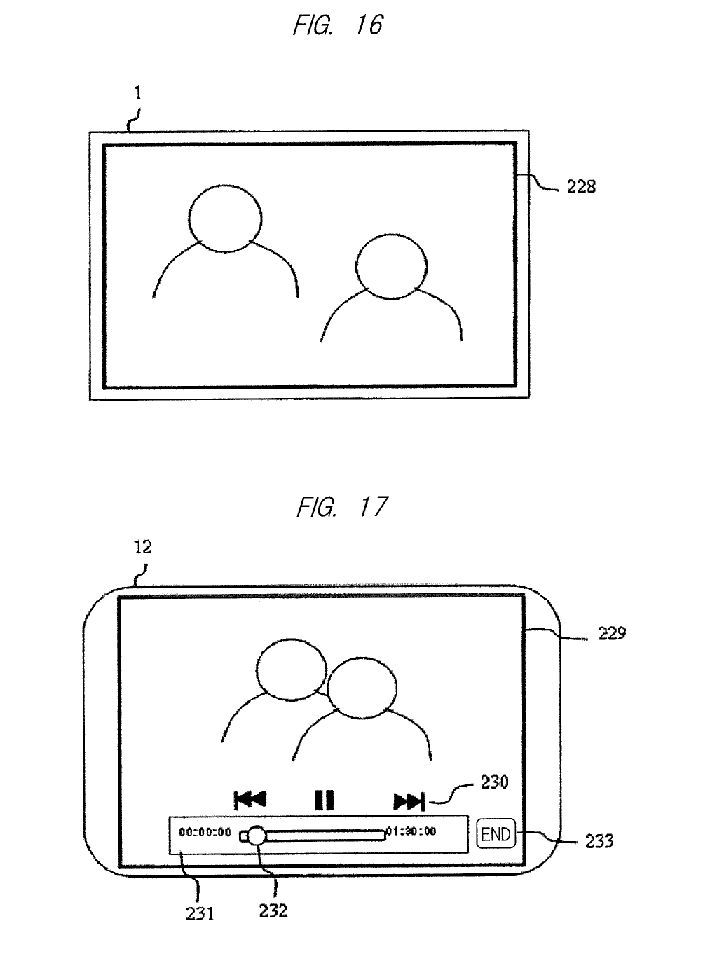

FIG. 16 is a diagram showing a display example in the case where the content is reproduced on the display screen 228 of the television receiver 1. As described with reference to FIG. 15(a) and FIG. 15(b), in the system according to the present embodiment, an interface for the reproducing operation of the content is displayed on the screen of the wireless terminal 12. Therefore, as shown in FIG. 16, on the display screen of the content displayed on the television receiver 1, the seek bar or the like which is displayed when moving images are reproduced in a PC or the like is not displayed and the content can be displayed on the entire screen of the television receiver 1, so that it is possible to provide a more comfortable viewing environment.

On the operation screen shown in FIG. 15(b), when an operation button for stopping the operation is selected on the operation display unit 227 (S926), the wireless terminal 12 transmits a stop request (stop command) to the television receiver 1 (S927). Moreover, upon detection of the end of the content (S928), the content distribution server 99 stops the distribution of the content (S929), and transmits a content distribution termination notification to the television receiver 1 (S930). Upon receipt of the notification of step S927 or step S930, the television receiver 1 stops the reproduction of the content (S931).

In this case, when the reproduction is stopped in step S931, the television receiver 1 may be returned to a state before the start of content reproduction. Moreover, in the case of the reproduction stop by way of S926, the information of the content reproduction stop position is stored in the resume information 1006 of the storage 23. Then, when the reproducing operation is again carried out through the wireless terminal 12 so as to resume the reproduction of the same content by the same user, the content reproduction unit 1013 of the television receiver 1 acquires the position data of the reproduction stop from the resume information 1006, so that the reproduction can be resumed from the reproduction start position corresponding to the position data. Alternatively, the content distribution server 99 may retain the information of the content reproduction stop position. In this case, the content distribution server 99 transmits the information of the content reproduction stop position together with the information of the content in step S922. In this manner, in the television receiver 1, the distribution is started from the reproduction start position calculated based on the information of the reproduction stop position acquired together with the information of the content from the content distribution server 99.

As described above, in the system according to the present embodiment, the reproducing operation of the content can be carried out by the wireless terminal at hand without presenting the display relating to the operations on the display screen of the television receiver 1.

Note that, in the case where any video image display device such as the television receiver 1 is not selected, but a “no connection (terminal)” 217 shown in FIG. 13 is selected in S907 of FIG. 9, the wireless terminal 12 directly downloads the information of the content from the content distribution server 99, and the content is displayed on the screen of the wireless terminal 12. In this case, as shown in FIG. 17, a reproducing bar display unit 230 is displayed in a superimposed manner on the content on the screen of the wireless terminal 12. On the reproducing bar display unit 230, the seek bar 231 and others are displayed like the case of FIG. 8. An operation display unit 232 is a unit for providing a reproducing operation instruction to the content reproduction unit 1113.

### Second Embodiment

In the present embodiment, the case where the reproducing operation of contents is carried out on the content distribution server 99 side will be described. In the description of the present embodiment, the distribution destination of the contents is the television receiver 1, but it may be the wireless terminal 12. Moreover, the description will be made with an emphasis on the difference from the first embodiment. Since the system configuration, the software configuration of the television receiver 1 and the software configuration of the wireless terminal 12 are the same as those of the first embodiment, the description thereof will be omitted.

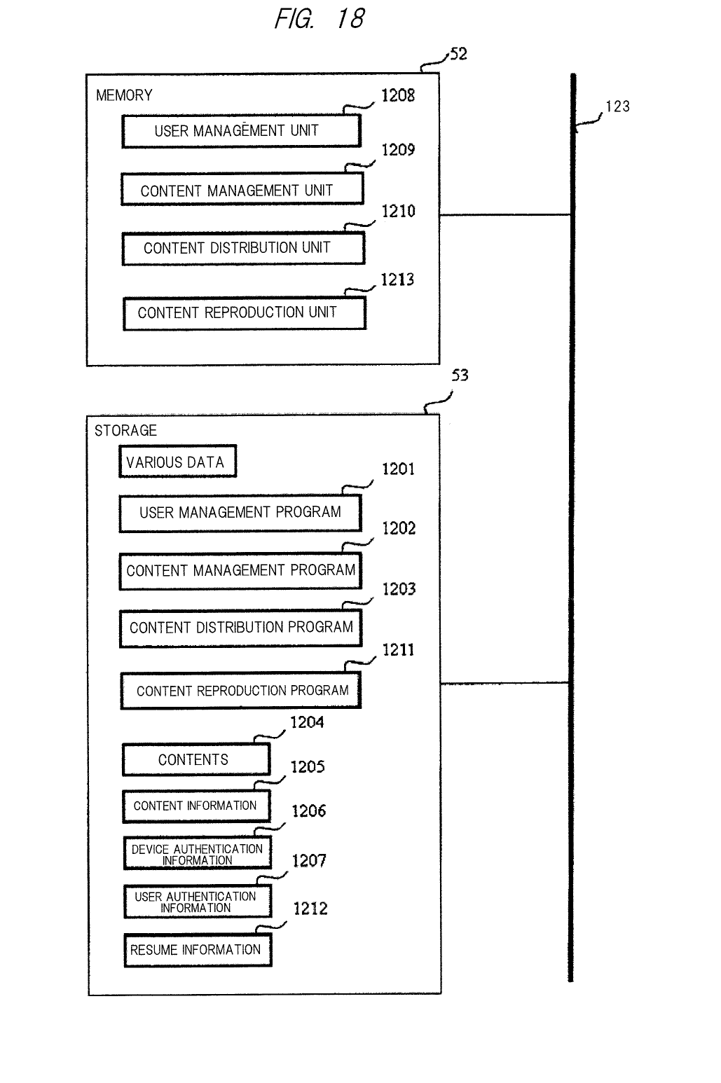

FIG. 18 is a diagram showing an example of information to be stored in the storage 53 and the memory 52 in the configuration of the content distribution server 99 in FIG. 4. In comparison with that of FIG. 7, the content distribution server 99 in the present embodiment is different in that a content reproduction program 1211 is stored in the storage 53. When the control unit 51 loads the content reproduction program 1211 into the memory 52, a content reproduction unit 1213 is configured in the memory 20.

For the sake of simplification, the following description will be made on the assumption that various functions realized by carrying out operations in accordance with each of application programs by the control unit 51 are realized mainly by the function unit for various programs.

Upon receipt of operation instructions such as the selection of contents, the determination of the content to be reproduced and the reproduction of the content from a device possessed by the user such as the wireless terminal 12 and the television receiver 1 through the communication interface 50, the content reproduction unit 1213 carries out reproducing controls such as reproduction, stop, fast-forwarding and fast-rewinding of the content (for example, movie, drama or the like) accumulated in the contents 54. The “reproduction” mentioned here corresponds to a process of reading information of a moving image format and carrying out a decoding process in accordance with its encode format, thereby producing image data and audio data to be displayed on the display device. Note that the data such as video data and audio data produced in the reproducing process are distributed by streaming from the content distribution unit 1210 through the communication interface 50. At this time, in order to reduce the network load, a compression process is carried out again.

Moreover, the information relating to the content reproduction stop position is stored in resume information 1212 of the storage 53, and in the case where the reproduction of the same content is resumed, the content reproduction unit 1213 acquires the data of the reproduction stop position from the resume information 1212 and determines it as the reproduction start position.

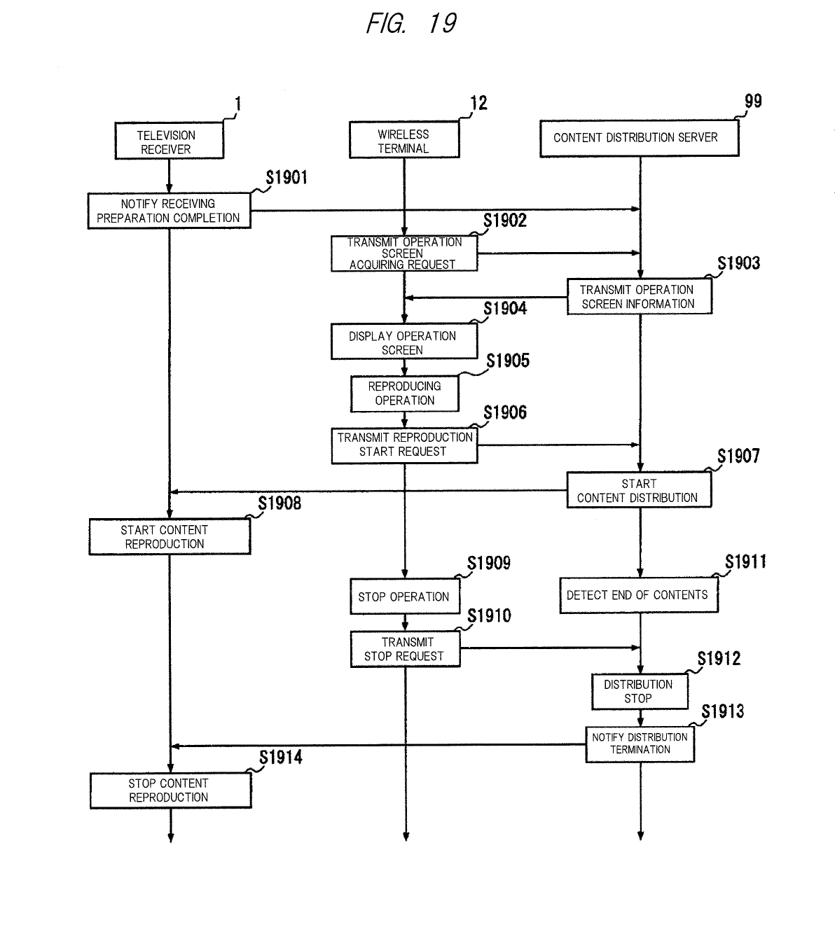

Next, referring to FIG. 19, the operations of a system according to the present embodiment will be described. FIG. 19 is a diagram showing a sequence of operations corresponding to those of FIG. 14 of the first embodiment, and as a premise for executing the operations shown in FIG. 19, the operations shown in FIG. 9 have been executed, and a preparation before starting the exchange of the content information between the television receiver 1 and the content distribution server 99 has been completed.

As shown in FIG. 19, after the process in S914 of FIG. 9, when the television receiver 1 receives the key information from the content distribution server 99, the television receiver 1 transmits a receiving preparation completion notification to the content distribution server 99 (S1901). Moreover, after the process of S912 of FIG. 9, the wireless terminal 12 transmits an operation screen acquiring request to the content distribution server 99 (S1902). Upon receipt of the receiving preparation completion notification from the television receiver 1 and the operation screen acquiring request from the wireless terminal 12, the content distribution server 99 transmits operation screen information to the wireless terminal 12 (S1903). Upon receipt of the operation screen information from the content distribution server 99, the wireless terminal 12 displays operation screens shown in FIGS. 15(a) and 15(b) on the display unit 17 (S1904). Note that the content distribution server 99 may transmit the operation screen information to the wireless terminal 12 based on only the receiving preparation completion notification from the television receiver 1.

On the operation screen shown in FIG. 15(a), when the “PLAY” of the operation display unit 227 is tapped by the user through the input unit 15 (S1905), the wireless terminal 12 transmits a reproduction start request to the content distribution server 99 (S1906). In the content distribution server 99, the content reproduction unit 1213 starts the reproduction of the content, and simultaneously distributes the reproduced content to the television receiver 1 based on the distribution start request from the wireless terminal 12 (S1907).

When the television receiver 1 starts displaying the content distributed from the content distribution server 99 (S1908), on the wireless terminal 12, a seek bar 225, a current reproducing time 223 and a length of the content 224 are displayed on a reproducing bar display unit 221 as shown in FIG. 15(b). By changing the reproducing position of the seek bar 225 laterally by a dragging operation, the reproduction can be started from the position at which the dragging operation is stopped. By the tapping operation to the operation display unit 227, a reproducing operation such as a fast-forwarding and fast-rewinding operation can be carried out.

In the case where an operation button for stopping the operation is selected on the operation display unit 227 (S1909), the wireless terminal 12 transmits a stop request to the content distribution server 99 (S1910). Upon receipt of the stop request from the wireless terminal 12 or upon detection of the end of the content (S1911), the content distribution server 99 stops the distribution of the content (S1912), and transmits a content distribution termination notification to the television receiver 1 (S1913). Upon receipt of the content distribution termination notification from the content distribution server 99, the television receiver 1 stops the reproduction of the contents (S1914).

As described above, in the system according to the present embodiment, in response to the operation by the user to the wireless terminal 12, the content distribution server 99 executes the reproducing process of the content, and the process to be executed by the television receiver 1 is only the process of displaying images based on the information received from the content distribution server 99. For this reason, it is possible to reduce the processing load of the television receiver 1.

Moreover, when the content reproduction processing functions are to be enhanced and added, in the case where the reproducing process is executed in the television receiver 1, the functions need to be added to the television receiver 1 itself, and hence each of the users has to add the functions. In contrast, in the case where the reproducing process of the contents is executed in the content distribution server 99, by adding the function of the reproducing process to the content distribution server 99 and updating the operation screen shown in FIG. 15(a) and FIG. 15(b) displayed on the wireless terminal 12, the added functions can be used by all the users and display devices to receive the distribution of the content.

### Third Embodiment

In the present embodiment, the case where content data are preliminarily downloaded from the content distribution server 99 to the television receiver 1 and then the reproducing operation is carried out will be described. In the description of the present embodiment, the download destination of the content data is the television receiver 1, but it may be the wireless terminal. Moreover, the description will be made with an emphasis on the difference from the first embodiment. Since the system configuration, the software configuration of the television receiver and the software configuration of the wireless terminal are the same as those of the first embodiment, the description thereof will be omitted.

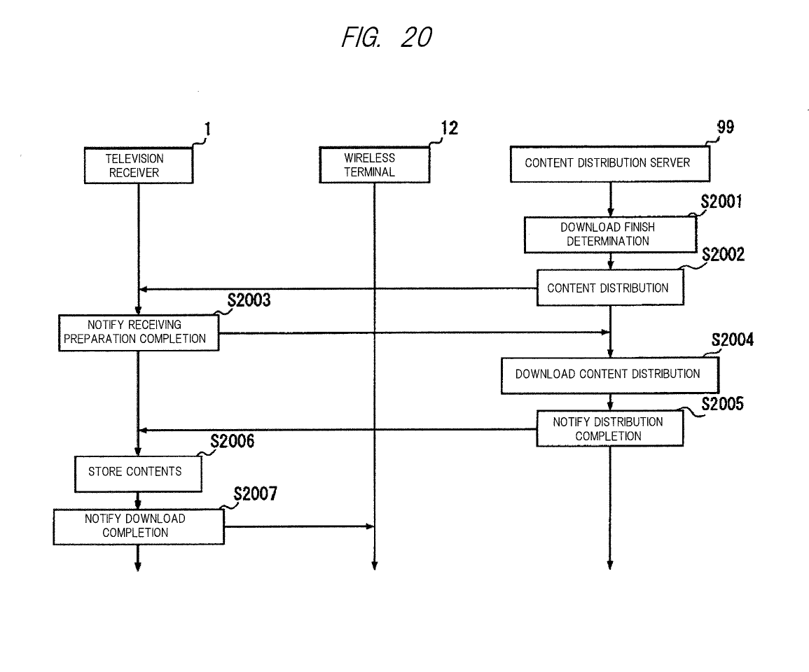

Referring to FIG. 20, the operations of the system in the present embodiment will be described. FIG. 20 is a diagram showing a sequence of operations in which the television receiver 1 preliminarily acquires the content data from the content distribution server 99 by downloading and accumulates the data in the storage 23, and as a premise for executing the operations shown in FIG. 20, the operations shown in FIG. 9 have been executed, and a preparation before starting the exchange of the content information between the television receiver 1 and the content distribution server 99 has been completed. Moreover, since it is not necessary to decode the content in the case of download, the process of S917 of FIG. 9 can be omitted in the operations to be carried out in all the steps of FIG. 20.

As shown in FIG. 20, in the content distribution server 99, after the determination in S915 and S916 of FIG. 9, the content management unit 1209 confirms whether or not the content selected in the access of S911 are previously downloaded by reference to the content information 1205 (S2001). In the case where the content has already been downloaded as a result of the confirmation, the content management unit 1209 transmits confirmation message information to the television receiver 1, thereby finishing the process. By this means, it is possible to prevent the content from being redundantly downloaded. Moreover, in the case where the content is damaged, lost or the like, the redownload may be permitted as long as the number of devices is within the permitted number of devices.

In the case where the content has not been downloaded as a result of the confirmation in S2001, the content distribution server 99 notifies the television receiver 1 of the permission of downloading (S2002). Upon receipt of the downloading permission notification, the television receiver 1 transmits a receiving preparation completion notification to the content distribution server 99 (S2003). The content distribution server 99 starts distributing the download content (S2004), and transmits a download content distribution completion notification to the television receiver 1 when the distribution is completed (S2005). The television receiver 1 stores the content in the storage 23 (S2006), and transmits a download completion notification to the wireless terminal 12 (S2007).

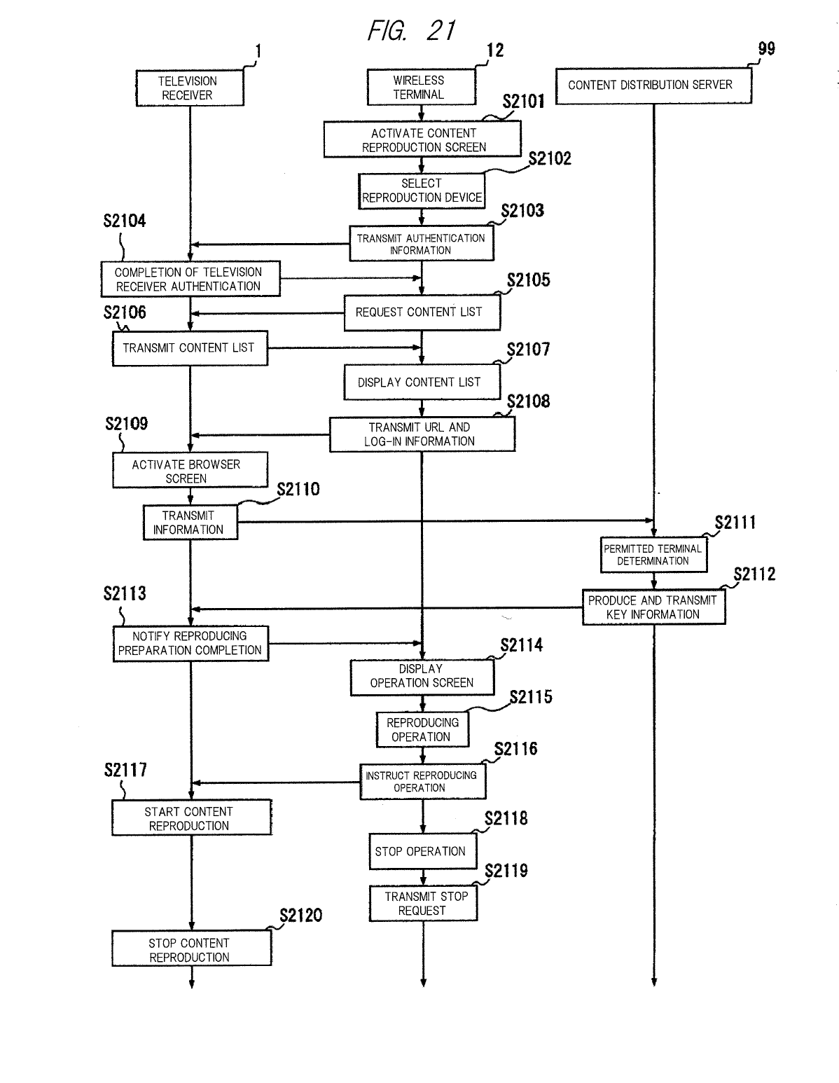

Next, referring to FIG. 21, the case where the television receiver 1 preliminarily acquires all the content data from the content distribution server 99 and the content is viewed and reproduced after the completion of the accumulation will be described. In this case, on a menu screen shown in FIG. 10, the user taps a “download content list” 301. In this manner, the control unit 14 of the wireless terminal 12 displays a connection device list display screen as described in FIG. 13 (S2101).

When the device on which the user desires to display the purchased contents is selected on the connection device list display screen shown in FIG. 13 by the operation of the user through the input unit 15 (S2102), the device authentication unit 1105 of the wireless terminal 12 transmits the preliminarily registered authentication information to the device authentication unit 1007 by way of the communication interface 13 and the communication interface 9 in order to receive the authentication from the television receiver 1 (S2103). The device authentication unit 1007 of the television receiver 1 compares authentication information stored in the device authentication information 1004 with the authentication information transmitted from the wireless terminal 12, and permits the connection of the wireless terminal 12 if they match with each other (S2104).

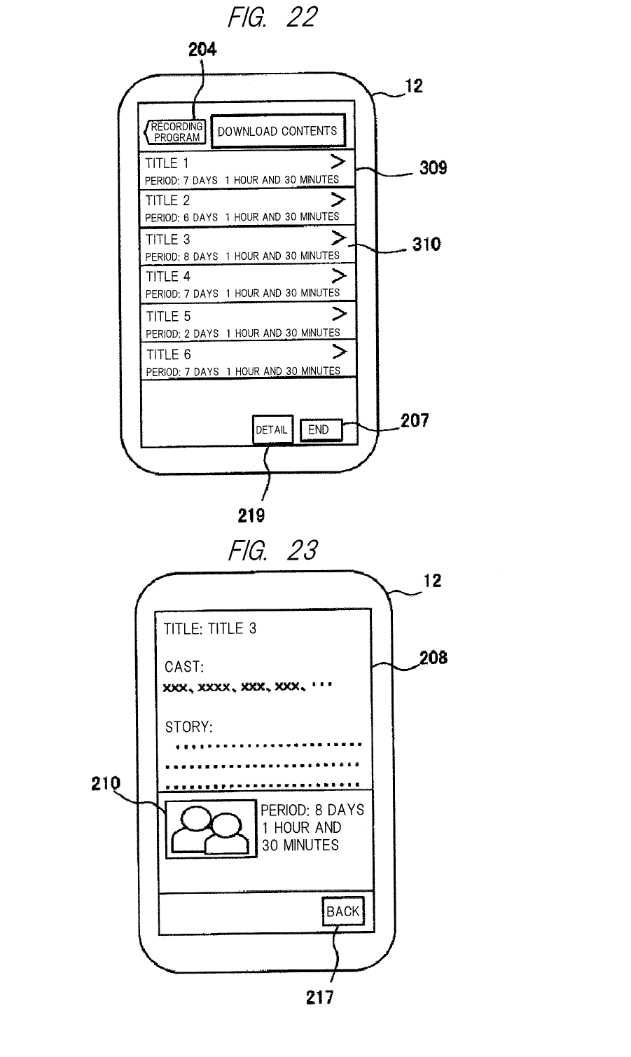

Next, the control unit 14 of the wireless terminal 12 requests the content list information to the television receiver 1 (S2105), the television receiver 1 transmits the content list information to the wireless terminal 12 (S2106), and the wireless terminal 12 displays a content list display screen as shown in FIG. 22 on the display unit 17 (S2107).

FIG. 22 is a diagram showing a display example of the content list display screen of the wireless terminal 12. As shown in FIG. 22, on a content title display 309, a content title name, a viewing period, a reproduction time, and the like are displayed. Moreover, a “detail” button 311 is an operation unit for instructing the switch to the screen for displaying the detail of the content as shown in FIG. 23. FIG. 23 shows a display example of the content detail display screen of the mobile terminal 12 with respect to the already downloaded content.

On the content list display screen shown in FIG. 22, when a title 310 of the contents which the user desires to view is selected by the operation of the user through the input unit 15, the control unit 14 transmits log-in information including a URL for accessing to the content distribution server 99 and a user name and a password for logging in to the television receiver 1 (S2108). The television receiver 1 activates the browser engine 1008 associated with the received URL (S2109).

Next, the television receiver 1 transmits the log-in information and the device authentication information stored in the device authentication information 1004 to the content distribution server 99 indicated by the URL received from the wireless terminal 12 (S2110). The content distribution server 99 determines whether or not the log-in information and the device authentication information received from the television receiver 1 match with the log-in information and the device authentication information of the distribution destination received from the wireless terminal 12 in step S911 of FIG. 9 (S2111). If they do not match with each other as a result of the determination, the content distribution server 99 transmits error information to the television receiver 1.

If they match with each other, the content distribution server 99 produces key information for decoding the information of encoded content, and transmits the key information to the television receiver 1 (S2112). Note that the transmission step of the key information is required only when the encoding of the content is required, and when the encoding is not required, the step may be omitted. The television receiver 1 stores the key information received from the content distribution server 99, and transmits a reproduction preparation completion notification to the wireless terminal 12 when the preparation for receiving the content is completed (S2113). Upon receipt of the reproduction preparation completion notification, the wireless terminal 12 displays an operation screen as shown in FIG. 15(b) on the display unit 17 (S2114).

When the user taps the “PLAY” of the operation display unit 227 shown on the operation screen of the wireless terminal 12 through the input unit 15 (S2115), the wireless terminal 12 transmits reproducing operation information to the television receiver 1 (S2116). Upon receipt of the reproducing operation information, the content reproduction unit 1013 in the television receiver 1 decodes the information of the selected content by using the decryption key stored in S2112, and starts the reproduction of the content (S2117). The screen display of the wireless terminal 12 after the start of the reproduction of the content is the same as that described above.

When an operation button for stopping the operation of the operation display unit 227 is selected on the operation screen shown in FIG. 15(b) (S2118), the wireless terminal 12 transmits a stop request to the television receiver 1 (S2119). In this manner, the television receiver 1 stops the reproduction of the content (S2120). Moreover, although not illustrated, when the end of the content is detected, the television receiver 1 stops the reproduction of the content.

As described above, in the system according to the present embodiment, in response to the operation by the user to the wireless terminal 12, the television receiver 1 downloads and accumulates the content information from the content distribution server 99. At this time, the device authentication information of the television receiver 1 is preliminarily notified to the content distribution server 99 from the wireless terminal 12 like the first embodiment. For this reason, upon receipt of a download request from the television receiver 1, the content distribution server 99 can confirm whether or not it is an authorized download request based on the device authentication information notified from the wireless terminal 12, and the security and copyright management can be ensured even in the case where a plurality of devices are operated in cooperation with one another.

Moreover, in the system according to the present embodiment, the device whose device authentication information has been once registered in the content distribution server 99 is allowed to download the content and acquire the key information in response to a request from the device to display the content without the necessity of transmitting the device authentication information from the wireless terminal 12 again, so that it becomes possible to improve the user convenience.

The present invention is not limited to the foregoing embodiments and various modifications and alterations can be made within the scope of the present invention. For example, in the embodiments above, the entire system has been described in detail so as to make the present invention easily understood, and the present invention is not always limited to the embodiment having all of the described constituent elements. Also, a part of the configuration of one embodiment may be replaced with the configuration of another embodiment, and the configuration of one embodiment may be added to the configuration of another embodiment. Furthermore, another configuration may be added to a part of the configuration of each embodiment, and a part of the configuration of each embodiment may be eliminated or replaced with another configuration.

Moreover, the entire or part of the above-mentioned configurations, functions, processing units, processing means and the like may be realized by hardware, for example, by designing them as integrated circuits. Furthermore, the above-mentioned configurations, functions and the like may be realized by software, for example, by allowing processors to interpret and execute the programs for realizing the respective functions. Information such as programs, tables and files for realizing the respective functions may be placed on a recording device such as a memory, a hard disk and an SSD (Solid State Drive) or a recording medium such as an IC card, an SD card, a DVD and the like.

Moreover, with respect to control lines and information lines, those considered to be required for the description are illustrated, and all the control lines and information lines on the product are not necessarily illustrated. Actually, it is safe to assume that almost all the configurations are connected to one another. In the description of the embodiments above, TV1, TV2 and others provided with the display unit 8 are used. However, the present invention can be similarly embodied also by an STB (Set Top Box), a recorder or the like having a display unit on its outside.

### DESCRIPTION OF REFERENCE CHARACTERS

1 Television receiver 1
2 Tuner-demodulator unit
3 Signal separation unit
4 Input unit
5 Control unit
6 Tuning control unit
7 Superimposing unit
8 Display unit
9 Communication interface
10 Wireless router
11 External network
12 Wireless terminal
13 Communication interface
14 Control unit
15 Input unit
17 Display unit
18 Base station
19 Television receiver 2
20 Memory
21 Signal separation unit
22 Tuner-demodulator unit
23 Storage
25 Storage
31 Mobile communication interface
32 Memory
33 Acceleration sensor unit
34 Geomagnetism sensor unit
35 GPS receiver unit
36 Gyro sensor unit
39 Audio decoder unit
40 Video decoder unit
41 Speaker
42 Audio output unit
43 Video output unit
44 Digital interface
50 Communication interface
51 Control unit
52 Memory
53 Storage
99 Content distribution server
999 Broadcasting station

What is claimed is:

1. A wireless operation controlling program for controlling viewing of content by a certain device by an operation through a wireless communication from another device, the program allowing an information processing device to execute the steps of:
displaying a device selection screen for selecting a device used in the viewing of content;
displaying a content selection screen for selecting content to be viewed;
notifying a content management device, which provides information to be acquired for the viewing of the content, of device identification information for identifying a device selected on the device selection screen and content identification information for identifying content selected on the content selection screen;
making the selected device have an access to the content management device by notifying the device selected on the device selection screen of a viewing instruction of the content selected on the content selection screen and information of an address to have an access to the content management device;
displaying an operation screen for controlling the viewing of the content; and
outputting a signal in accordance with an operation to the operation screen.

2. The wireless operation controlling program according to claim 1, further allowing the information processing device to execute the step of: displaying a log-in screen to which log-in information for logging in the content management device is input,
wherein, in the step of notifying the device selected on the device selection screen of information of an address to have an access to the content management device, log-in information input on the log-in screen is also notified.

3. The wireless operation controlling program according to claim 1,
wherein, in the case where the device selected on the device selection screen is a previously selected device, the step of notifying the content management device of the device identification information for identifying the device selected on the device selection screen is omitted.

4. The wireless operation controlling program according to claim 1, further allowing the information processing device to execute the step of: carrying out an authentication process between the information processing device and the device used for the viewing of the content,
wherein, in the step of notifying the content management device of the device identification information for identifying the device selected on the device selection screen, the device identification information obtained by the authentication process is notified.

5. The wireless operation controlling program according to claim 1,
wherein the information to be acquired for the viewing of the content is information of the content.

6. The wireless operation controlling program according to claim 1,
wherein the information to be acquired for the viewing of the content is information for decoding information of encoded content.

7. A wireless terminal for controlling viewing of content by a certain device by an operation through a wireless communication from another device, the wireless terminal comprising:
a device selection screen display unit for displaying a device selection screen for selecting a device to be used for the viewing of content on a display unit;
a content selection screen display unit for displaying a content selection screen for selecting the content to be viewed on the display unit;
an identification information notification unit for notifying a content management device, which provides information to be acquired for the viewing of the content, of device identification information for identifying a device selected on the device selection screen and content identification information for identifying contents selected on the content selection screen;
a viewing instruction notification unit for notifying the device selected on the device selection screen of a viewing instruction of the content selected on the content selection screen and information of an address to have an access to the content management device;
an operation screen display unit for displaying an operation screen for controlling the viewing of the content on the display unit; and
an operation signal output unit for outputting a signal in accordance with an operation to the operation screen.

8. A content management device, which provides information relating to contents in a content viewing system in which viewing of contents by a certain device is controlled by an operation through a wireless communication from another device, the device comprising:
a device identification information acquiring unit for acquiring device identification information for identifying a device selected as a device to be used for the viewing of the contents;
an information acquiring request receiver unit for receiving an acquiring request of information to be acquired by the device at the viewing of the contents from the selected device; and
a device determination unit which, if a transmission source of the received acquiring request matches with the acquired device identification information, transmits the information to be acquired by the device at the viewing of the contents to the transmission source of the acquiring request.

9. A content viewing system comprising: a wireless terminal for controlling viewing of contents by a certain device by an operation through a wireless communication from another device;
and a content management device for providing information relating to the contents to a device used for the viewing of the contents,
wherein the wireless terminal includes:
a device selection screen display unit for displaying a device selection screen for selecting a device to be used for the viewing of the contents on a display unit;
a content selection screen display unit for displaying a content selection screen for selecting content to be viewed on the display unit;
an identification information notification unit for notifying the content management device of device identification information for identifying a device selected on the device selection screen and content identification information for identifying content selected on the content selection screen;
a viewing instruction notification unit for notifying the device selected on the device selection screen of a viewing instruction of the content selected on the content selection screen and information of an address to have an access to the content management device;
an operation screen display unit for displaying an operation screen for controlling the viewing of the content on the display unit; and
an operation signal output unit for outputting a signal in accordance with an operation to the operation screen, and
the content management device includes:
a device identification information acquiring unit for acquiring device identification information for identifying a device selected as a device to be used for the viewing of the content;
an information acquiring request receiver unit for receiving an acquiring request of information to be acquired by the device at the viewing of the content from the selected device; and
a device determination unit which, if a transmission source of the received acquiring request matches with the acquired device identification information, transmits the information to be acquired by the device at the viewing of the content to the transmission source of the acquiring request.
